(19) United States
(12) Patent Application Publication
(10) Pub. No.: US 2023/0398546 A1
(43) Pub. Date: Dec. 14, 2023

(54) SYSTEMS FOR RECONSTITUTING DRIED REAGENT COMPOSITIONS AND METHODS FOR USING THE SAME

(71) Applicant: Becton, Dickinson and Company, Franklin Lakes, NJ (US)

(72) Inventor: Daniel B. Sell, San Jose, CA (US)

(21) Appl. No.: 18/206,447

(22) Filed: Jun. 6, 2023

Related U.S. Application Data
(60) Provisional application No. 63/350,794, filed on Jun. 9, 2022.

(51) Int. Cl. B01L 3/00

(52) U.S. Cl. CPC B01L 3/523; B01L 2200/16; B01L 2300/0832; B01L 2300/04

(57) ABSTRACT

Systems for reconstituting dried reagent compositions are provided. Aspects of the systems include a liquid container with an inner wall having a dried reagent composition and a solid volume displacer configured to be positioned inside of the liquid container to occupy a majority of the liquid container volume below the top of the dried reagent composition. Aspects of the invention further include methods of using the system and kits that include the system.

### CROSS-REFERENCE TO RELATED APPLICATION

Pursuant to 35 U.S.C. § 119 (e), this application claims priority to the filing date of U.S. Provisional Patent Application Ser. No. 63/350,794 filed Jun. 9, 2022; the disclosure of which application is incorporated herein by reference in its entirety.

### INTRODUCTION

Assays for determining the presence and concentration of analytes in a biological sample fluid often rely on the specific binding of a detectable label to the target analyte. The detectable label may be a marker that can be visualized either by an unaided eye or detectable by spectroscopy, such as fluorescence or UV-vis spectroscopy. Typically, fluorescent dyes may be used as the detectable label, where the fluorescent dye includes a particular fluorochrome. A fluorochrome may have certain properties, such as its absorption spectrum, its extinction coefficient at a wavelength convenient for excitation, its emission spectrum, and its quantum efficiency. Quantum efficiency is the number of photons emitted for every photon absorbed.

Multiplexed assays allow simultaneous detection of multiple analytes in a single assay. For immunoassays, multiplexed assays involve a cocktail of antibodies, each labeled with a different dye. Each antibody binds to a specific analyte or antigen in the sample. In this way, the different analytes or antigens can be differentiated and quantitated based on the different dyes.

For convenience, multiplex assay reagents can be supplied as a premixed cocktail of individual binding molecules, such as antibodies. Other reaction components may be included in the cocktail, such as buffer, salt, surfactant, etc. Most convenient is a cocktail containing all necessary components (a unitary assay reagent). In this case, the assay can be performed by simply adding sample to a reaction vessel containing the cocktail.

It is convenient to provide a stable assay reagent, particularly a reagent that is stable at room temperature. This allows shipment and storage of the reagent without refrigeration. This is especially important for assays performed in rural areas where resources, including electricity, may be limited. To this end, stable reagents may be provided by drying down aqueous solutions of the reagent, or by lyophilization. But a problem exists with some labeled reagents. These reagents become cross-linked if they physically touch one another. They remain cross-linked after resuspension in liquid solution, so that the labels are no longer associated with individual antibodies, causing erroneous results. This can be especially problematic, for example, in the field of flow cytometry, in which a plurality of polymeric dyes are used to create multiple, e.g., 10 or more, fluorescent channels by using only one wavelength for excitation. The chemical nature of these polymeric dyes, however, prevents the storage of multiple dyes in a pooled cocktail. It has been observed that the polymeric entities bind with each other in solution. This results in either erroneous or anomalous cell populations that cannot exist in reality.

U.S. Pat. No. 10,545,137 discloses a reagent device having a solid support, and first and second dried polymeric dye compositions distinctly positioned relative to a surface of the solid support, thereby reducing dye-dye interactions as compared to reagent devices in which two or more dye compositions are provided but are not distinctly positioned relative to each other. When it comes time for use, the distinctively positioned dye compositions can be reconstituted by introducing an aqueous liquid into contact with the dye compositions. Reagent concentrations must be maintained for good assay performances. As such, the aqueous liquid introduced into contact with the dye compositions may be the biological sample fluid in order to maintain the reagents and analytes of the sample at a desired concentration.

### SUMMARY

However, in the device of U.S. Pat. No. 10,545,137, although dye-dye interactions are reduced, the present inventors have realized that the large volume of liquid required to reconstitute the distinctly positioned dye compositions may result in reduced dye concentrations. This issue is amplified with increasing numbers of distinctly positioned dye compositions, effectively limiting the number of dye compositions that can be used in assays performed with the device.

For this reason, the inventors have realized that it is desirable for the dye composition(s) to be reconstituted with a small volume of liquid.

The present disclosure is made in view of such circumstances, and an objective thereof is to provide a system for reconstituting dried reagent compositions capable of reducing the volume of liquid required to reconstitute the dried reagent compositions. Accordingly, embodiments of the invention reduce the volume of liquid required to reconstitute or rehydrate a dried reagent composition or compositions.

Systems for reconstituting dried reagent compositions are provided. Aspects of the systems include a liquid container with an inner wall having a dried reagent composition and a solid volume displacer configured to be positioned inside of the liquid container to occupy a majority of the liquid container volume below the top of the dried reagent composition. Aspects of the invention further include methods of using the system and kits that include the system.

### BRIEF DESCRIPTION OF THE FIGURES

FIG. 1 provides an illustration of a system in accordance with an embodiment of the invention.

FIGS. 2A to 2C provide an illustration of a method for reconstituting dried reagent compositions using the system of FIG. 1.

FIGS. 3A to 3B provide a comparison between the volume of liquid required to reconstitute a dried reagent composition using a system according to an embodiment of the invention as opposed where a system of invention is not employed.

FIGS. 4A-4B provide a depiction of a stepped solid volume displacer in accordance with an embodiment of the invention.

FIGS. 5A-5B provide a depiction of a straight solid volume displacer in accordance with an embodiment of the invention.

### DETAILED DESCRIPTION

Systems for reconstituting dried reagent compositions are provided. Aspects of the systems include a liquid container with an inner wall having a dried reagent composition and a solid volume displacer configured to be positioned inside of the liquid container to occupy a majority of the liquid container volume below the top of the dried reagent composition. Aspects of the invention further include methods of using the system and kits that include the system.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

While the apparatus and method has or will be described for the sake of grammatical fluidity with functional explanations, it is to be expressly understood that the claims, unless expressly formulated under 35 U.S.C. § 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 U.S.C. § 112 are to be accorded full statutory equivalents under 35 U.S.C. § 112.

As summarized above, systems for reconstituting dried reagent compositions are provided. In further describing various embodiments of the invention, the subject systems are first described in greater detail. Next, methods of using the subject systems are provided, as well as kits including the same.

### Systems for Reconstituting Dried Reagent Compositions

Embodiments of the invention include a system for reconstituting dried reagent compositions that has been optimized for the purpose of reconstituting or rehydrating a dried reagent composition or dried reagent compositions, ultimately to be used for assays, for example, assays of a liquid sample. Aspects of the systems include a liquid container with an inner wall having a dried reagent composition and a solid volume displacer configured to be positioned inside of the liquid container to occupy a majority of the liquid container volume below the top of the dried reagent composition. The systems allow for the controlled displacement of a volume of liquid in a manner sufficient to reconstitute a dried reagent composition or compositions, which can provide for a number of advantages including, but not limited to, improvements in usability, cost and performance.

### Liquid Containers

As summarized above, systems of the invention include liquid containers. In certain embodiments, the liquid containers are useful in assays, for example, assays of a liquid sample, such as a biological sample, e.g., for the presence of one or more analytes in the sample. Liquid containers according to certain embodiments of the present disclosure include an open end and a bottom separated by a wall therebetween, wherein an inner surface of the wall includes a dried reagent composition.

The liquid container can be any convenient container that is compatible with the liquid sample and/or reagent(s) or analyte(s) that may be in contact with the container. For example, the liquid container can be a liquid-compatible container configured to contain a liquid sample. In some cases, the liquid sample may be an aqueous liquid sample, and in these cases, the liquid container may be compatible with aqueous samples. By “compatible” is meant that the liquid container (e.g., the material the container is made of) is substantially inert with respect to (e.g., does not significantly react with) the liquid and/or reagent(s) or analyte(s) in contact with the container.

The liquid container may include an open end and a bottom opposing the open end. In these instances, the open end of the liquid container (e.g., through an opening) exposes the interior of the liquid container to the surrounding environment, e.g., such that the contents of the liquid container are under the same atmospheric pressure as the surrounding environment. The longest cross-sectional dimension of the liquid container, e.g., diameter, may vary, and in some instances ranges from 0.5 cm to 5 cm, such as 0.5 cm to 4.5 cm, or 0.5 cm to 4 cm, or 0.5 cm to 3.5 cm, or 0.5 cm to 3 cm, or 0.5 cm to 2.5 cm, or 0.5 cm to 2 cm, or 0.5 cm to 1.5 cm, or 0.5 cm to 1.2 cm, or 0.9 cm to 1.0 cm. In some embodiments, the open end of the liquid container may include a protrusion, e.g., such that a snap-on cap may be applied to the open end. In other embodiments, the open end of the liquid container may include a threading, e.g., such that a threaded cap can be screwed over the opening of the open end.

In some instances, the bottom of the liquid container opposite the open end may include a closed end with the wall rising therefrom. As such, the liquid container may be configured to hold a certain volume of a fluid (e.g., gas or liquid). In certain embodiments, the liquid container is configured to hold a certain volume of a liquid. The size of the liquid container may depend on the volume of liquid to be held in the liquid container. For instance, the liquid container may be configured to hold a volume (e.g., a volume of a liquid) ranging from 0.1 ml to 1000 ml, such as from 0.1 ml to 900 ml, or 0.1 ml to 800 ml, or 0.1 ml to 700 ml, or 0.1 ml to 600 ml, or 0.1 ml to 500 ml, or 0.1 ml to 400 ml, or 0.1 ml to 300 ml, or ml to 200 ml, or 0.1 ml to 100 ml, or 0.1 ml to 50 ml, or 0.1 ml to 25 ml, or 0.1 ml to 10 ml, or 0.1 ml to 5 ml, or 0.1 ml to 1.5 ml, or 0.1 ml to 1 ml, or 0.1 ml to 0.5 ml. In certain instances, the liquid container is configured to hold a volume (e.g., a volume of a liquid) ranging from 0.1 ml to 200 ml, such as 0.5 ml to 100 ml, e.g., 1.0 ml to 50 ml.

The shape of the liquid container may vary and may depend on the use of the container. For example, as described herein, the liquid container may find use in an assay, such as an assay of a liquid sample (e.g., a biological sample). In these cases, the liquid container may be configured in a shape that is compatible with the assay and/or the method or other devices used to perform the assay. For instance, the liquid container may be configured in a shape of typical laboratory equipment used to perform the assay or in a shape that is compatible with other devices used to perform the assay. In certain embodiments, the wall of the liquid container is in the shape of a cylinder, where the cylinder has an opening at a first end and a closed bottom joined to the cylinder at a second end opposing the first end. In some cases, the liquid container has a circular cross section. The shape of the liquid container may vary and may depend on the use of the solid volume displacer. For example, the liquid container may be configured in a shape that is compatible with the methods of the present disclosure. In some embodiments the wall of the liquid container is tapered. In some cases, the liquid container may be conical, or may include a conical section. For example, the liquid container may include a substantially cylindrical wall section adjacent to an opening at a first end and a conical wall section adjacent to a second closed end opposing the first end. In some embodiments the bottom of the liquid container is rounded. In some embodiments, the liquid container may be a vial, a test tube or a centrifuge tube (e.g., a microcentrifuge tube). In certain cases, the liquid container is a vial. In certain cases, the liquid container is a test tube. As described above, the liquid container may be configured to hold a volume (e.g., a volume of a liquid). In embodiments where the liquid container is a vial or a test tube, the liquid container may be configured to hold a volume (e.g., a volume of a liquid) ranging from 1*10⁻⁷ ml to 1000 ml, such as from 0.5 ml to 900 ml, or 0.5 ml to 800 ml, or 0.5 ml to 700 ml, or 0.5 ml to 600 ml, or 0.5 ml to 500 ml, or ml to 400 ml, or 0.5 ml to 300 ml, or 0.5 ml to 200 ml, or 0.5 ml to 100 ml, or 0.5 ml to 50 ml, or 0.5 ml to 25 ml, or 0.5 ml to 10 ml, or 0.5 ml to 5 ml, or 1 ml to 5 ml. In certain instances, the vial or test tube is configured to hold a volume (e.g., a volume of a liquid) ranging from 0.5 ml to 5 ml.

In certain embodiments, the liquid container has a width (which may also be referred to as the diameter for cylindrical liquid containers) ranging from 0.5 cm to 5 cm, such as 0.5 cm to 4.5 cm, or 0.5 cm to 4 cm, or 0.5 cm to 3.5 cm, or 0.5 cm to 3 cm, or 0.5 cm to 2.5 cm, or 0.5 cm to 2 cm, or 0.5 cm to 1.5 cm, or 0.5 cm to 1.2 cm, or 0.9 cm to 1.0 cm. In some instances, the liquid container has a width (or diameter) ranging from 0.5 cm to 2.5 cm. In some instances, the liquid container has a width (or diameter) ranging from 0.5 cm to 1.2 cm such as, e.g., from 0.9 cm to 1.0 cm. In certain embodiments, the liquid container has a length ranging from 1 cm to 20 cm, such as 1 cm to 15 cm, or 1 cm to 10 cm, or 1 cm to 5 cm, or 1 cm to 2.5 cm. In some instances, the liquid container has a length ranging from 1 cm to 10 cm. In some instances, the liquid container has a length ranging from 1 cm to 5 cm. In some instances, the liquid container has a length ranging from 1 cm to 2.5 cm.

As described above, embodiments of the liquid container can be compatible with the liquid sample and/or reagent(s) or analyte(s) in contact with the container. Examples of suitable container materials include, but are not limited to, ceramics, metals (e.g., stainless steel, aluminum, anodized aluminum, titanium, copper, bronze, nickel, etc.), resins, paper, glass, and plastic. For example, the container may be composed of glass, such as, but not limited to, silicate glass, borosilicate glass, sodium borosilicate glass (e.g., PYREX™), fused quartz glass, fused silica glass, and the like. Other examples of suitable container materials include polymeric materials. The polymeric material may be a hydrophobic polymeric material. The hydrophobic polymeric material may be a plastic, such as, but not limited to, polystyrene, polypropylene, polymethylpentene, polytetrafluoroethylene (PTFE), perfluoroethers (PFE), fluorinated ethylene propylene (FEP), perfluoroalkoxy alkanes (PFA), polyethylene terephthalate (PET), polyethylene (PE), low-density polyethylene (LDPE), polyetheretherketone (PEEK), and the like.

In some embodiments, as described above, the liquid container is configured to hold a certain volume of a fluid (e.g., gas or liquid). In some instances, the liquid container is configured for holding a certain volume of a liquid. In some embodiments the liquid container may be sealed. That is, the liquid container may include a seal that substantially prevents the contents of the liquid container (e.g., liquid inside the liquid container) from exiting the liquid container. The seal of the liquid container may also substantially prevent other substances from entering the liquid container. For example, the seal may be a water-tight seal that substantially prevents liquids from entering or exiting the container, or may be an air-tight seal that substantially prevents gases from entering or exiting the container. In some instances, the seal is a removable or breakable seal, such that the contents of the liquid container may be exposed to the surrounding environment when so desired, e.g., if it is desired to remove a portion of the contents of the liquid container. In some instances, the seal is made of a resilient material to provide a barrier (e.g., a water-tight and/or air-tight seal) for retaining a sample in the container. Particular types of seals include, but are not limited to, films, such as polymer films, caps, etc., depending on the type of container. Suitable materials for the seal include, for example, rubber or polymer seals, such as, but not limited to, silicone rubber, natural rubber, styrene butadiene rubber, ethylene-propylene copolymers, polychloroprene, polyacrylate, polybutadiene, polyurethane, styrene butadiene, and the like, and combinations thereof. For example, in certain embodiments, the seal is a septum pierceable by a needle, syringe, or cannula. The seal may also provide convenient access to a sample in the liquid container, as well as a protective barrier that overlies the opening of the container. In some instances, the seal is a removable seal, such as a threaded or snap-on cap or other suitable sealing element that can be applied to the opening of the liquid container. For instance, a threaded cap can be screwed over the opening before or after a sample has been added to the liquid container.

As described above, the liquid container may be configured to hold a certain volume of a fluid (e.g., gas or liquid). In some instances, the bottom of the liquid container has an inner surface and an outer surface. In some instances, the wall of the liquid container has an inner surface and an outer surface. In these embodiments, the inner surfaces of the liquid container are the surfaces of the liquid container facing toward the inside of the container. The inner surfaces may be in contact with the contents of the liquid container. The outer surfaces of the liquid container are the surfaces of the container facing away from the inside of the container. The outer surfaces do not contact the contents of the liquid container.

As reviewed above, the liquid container may include a dried reagent composition. In certain embodiments, the dried reagent composition is positioned on a surface (e.g., inner surface) of the liquid container. By reagent is meant a substance or compound that interacts with other substances or compounds in order to, e.g., facilitate a chemical reaction or test if a reaction has occurred. For example, the substance or compound may include, but is not limited to, beads, preservatives, surfactants, anti-foaming agents, buffers (e.g., pH buffers), reactants, specific binding members (e.g., antibodies), dyes, etc. By dried is meant the reagent composition includes a low amount of solvent (or, e.g., substantially no solvent), or the reagent composition is able to have its viscosity lowered by combining it with a volume of solvent. For example, in some embodiments a dried reagent composition may be a liquid with a relatively high viscosity (e.g., a syrup) in which the addition of a volume of solvent (e.g., water) may lower the viscosity of the reagent composition by 10 cP or more, or 100 cP or more, or 500 cP or more, or 1,000 cP or more, or 10,000 cP or more, or 100,000 cP or more, or 250,000 cP or more, or 1,000,000 cP or more, at standard conditions. In certain embodiments, a dried reagent composition includes 25 wt % or less solvent, such as 20 wt % or less, or 15 wt % or less, or 10 wt % or less, or 5 wt % or less, or 3 wt % or less, or 1 wt % or less, or 0.5 wt % or less solvent. In some cases, a dried reagent composition is not a fluid. In some cases, a dried reagent composition is substantially a solid. For example, a dried reagent composition may have a high viscosity, such as a viscosity of 10,000 cP or more, or cP or more, or 50,000 cP or more, or 75,000 cP or more, or 100,000 cP or more, or 150,000 cP or more, or 200,000 cP or more, or 250,000 cP or more at standard conditions. In some embodiments, a dried reagent may be dissolved, either partially or completely, in a volume of solvent. For example, a dried reagent composition may be rehydrated or reconstituted in water. In some embodiments, a dried reagent composition is able to maintain its shape and position (e.g., on the inner surface of the liquid container where the composition is adhered, as discussed in greater detail below) before it is contacted by a solvent.

In some instances, the dried reagent composition is positioned on the inner surface of the wall of the liquid container. The liquid container may include one or more dried reagent compositions (e.g., dye compositions) on a container surface such as the inner surface of the wall of the liquid container, such as 2 or more dried reagent compositions, or 3 or more, or 4 or more, or 5 or more, or 6 or more, or 7 or more, or 8 or more, or 9 or more, or 10 or more, or 11 or more, or 12 or more, or 13 or more, or 14 or more, or 15 or more, 16 or more, or 17 or more, or 18 or more, or 19 or more, or 20 or more, or 25 or more, or 30 or more, or 35 or more, or 40 or more, or 45 or more, or 50 or more dried reagent compositions on the inner surface of the wall of the liquid container. In some embodiments, the container includes 2 to 50 dried reagent compositions on the inner surface, such as 2 to 40, or 2 to 30, or 2 to 20, or 2 to 15, or 2 to 10, or 2 to 7, or 2 to 5 dried reagent compositions on the inner surface of the wall. For example, the container may include 2, or 3, or 4, or 5, or 6, or 7, or 8, or 9, or 10, or 11, or 12, or 13, or 14, or 15, or 16, or 17, or 18, or 19, or 20 dried reagent compositions on the inner surface of the wall of the liquid container. In certain cases, the liquid container includes 2 dried reagent compositions on the inner surface of the wall of the liquid container. In certain cases, the liquid container includes 5 dried reagent compositions on the inner surface of the wall of the liquid container. In certain cases, the liquid container includes 7 dried reagent compositions on the inner surface of the wall of the liquid container. In certain cases, the liquid container includes 10 dried reagent compositions on the inner surface of the wall of the liquid container. In certain cases, the liquid container includes 15 dried reagent compositions on the inner surface of the wall of the liquid container.

As described above, the container may include two or more dried reagent compositions positioned relative to a surface of the container (e.g., the inner surface of the wall of the liquid container). In some instances, the wall of the liquid container may include a second dried reagent composition positioned on the inner surface thereof. In some instances, the first and second, e.g., two or more, dried reagent compositions are adhered to the inner surface of the wall of the liquid container. By adhered is meant that the dried reagent compositions are stably associated with the location of the inner surface where they are positioned, such that they do not move from the location of the inner surface where they are positioned when in the dry state. Upon reconstitution, the reagents, e.g., dyes, of the dried reagent compositions are dissociated from the surface location where they are positioned, such that they are present in the liquid that was employed to reconstitute the dried reagent compositions. The dried reagent compositions may be located on the inner surface of the wall of the liquid container in distinct positions. For example, first and second dried reagent compositions may be distinctly positioned on the inner surface of the wall of the liquid container. By “distinct position” or “distinctly positioned” is meant that a dried reagent composition is disposed at a position different from the position of another dried reagent composition. The position of a dried reagent composition may refer to the location of the dried reagent composition on the surface of the liquid container, and/or may refer to the position of the dried reagent composition relative to the surface of the liquid container. In some cases, a dried reagent composition occupies a defined volume of space. For example, a dried reagent composition may occupy a volume of space on a surface of the liquid container. A distinctly positioned dried reagent composition may occupy a volume of space that does not significantly coincide or overlap with a volume of space occupied by another dried reagent composition, where in some instances it does not coincide or overlap at all with a volume of space occupied by another dried reagent composition. Embodiments where dried reagent compositions are distinctly positioned may provide for a minimization in interactions, e.g., dye-dye interactions, between each of the dried reagent compositions.

Stated another way, a distinctly positioned dried reagent composition is not significantly mixed together with another dried reagent composition (e.g., polymeric dye composition), e.g., substantially no portion of the distinctly positioned dried reagent composition is mixed with a portion of another dried reagent composition (e.g., polymeric dye composition). In some instances, a distinctly positioned dried reagent composition is not mixed together with another dried reagent composition (e.g., polymeric dye composition), e.g., no portion of the distinctly positioned dried reagent composition is mixed with a portion of another dried reagent composition (e.g., polymeric dye composition). In certain embodiments, a distinctly positioned dried reagent composition includes a single reagent. For example, a distinctly positioned dried reagent composition may be substantially composed of a single reagent and does not include another reagent in a significant amount. A distinctly positioned dried reagent composition may include a large excess of a reagent with respect to any other reagent that may be in the dried reagent composition, such as, for example, 75 wt % or more, such as 80 wt % or more, or 85 wt % or more, or 90 wt % or more, or 95 wt % or more, or 97 wt % or more or 99 wt % or more, or 100 wt % of a reagent with respect to any other reagent that may be in the dried reagent composition. In certain embodiments, a distinctly positioned dried reagent composition includes a single dye. For example, a distinctly positioned dried reagent composition may be substantially composed of a single dye and does not include another dye in a significant amount. A distinctly positioned dried reagent composition may include a large excess of a dye with respect to any other dye that may be in the dried reagent composition, such as, for example, 75 wt % or more, such as 80 wt % or more, or 85 wt % or more, or 90 wt % or more, or 95 wt % or more, or 97 wt % or more or 99 wt % or more, or 100 wt % of a dye with respect to any other dye that may be in the dried reagent composition. In some instances, the dried reagent composition(s) include two or more reagents. In some instances, the first and/or second dried reagent composition includes two or more reagents including, e.g., three or more reagents, four or more reagents, five or more reagents, six or more reagents, seven or more reagents, eight or more reagents, nine or more reagents, or ten or more reagents. In some instances, the dried reagent composition(s) include two or more dyes. In some instances, the first and/or second dried reagent composition includes two or more dyes including, e.g., three or more dyes, four or more dyes, five or more dyes, six or more dyes, seven or more dyes, eight or more dyes, nine or more dyes, or ten or more dyes.

In some instances, distinctly positioned dried reagent compositions are spaced apart from the bottom of the liquid container. A dried reagent composition that is spaced apart from the bottom of the liquid container may be physically separated from the bottom of the liquid container. For instance, a distinctly positioned dried reagent composition may be positioned on the inner surface of the wall of the liquid container at a distance apart from the bottom of the liquid container such that there is a certain distance between the edge of the dried reagent composition closest to the bottom of the liquid container and the edge of the bottom of the liquid container closest to the dried reagent composition. An edge of the bottom of the liquid container can be any point where the bottom of the liquid container contacts the wall of the liquid container. In some embodiments, the bottom of the liquid container is considered to contact the wall of the liquid container where the wall of the liquid container no longer has a particular shape or no longer continues at a particular angle. In embodiments where the wall of the liquid container is in the shape of a cylinder (e.g., a tapered cylinder) and the bottom of the liquid container is rounded, the bottom of the liquid container can be considered to contact the wall of the liquid container at the location wherein opposing horizontal ends of the wall of the liquid container no longer run parallel to each other, or no longer run substantially parallel to each other in embodiments where the cylinder is tapered (i.e., where the liquid container ceases to be a cylinder and instead resembles e.g., a hemisphere). In some embodiments, the distance between a dried reagent composition on the inner surface of the wall of the liquid container and the bottom of the liquid container is 0.1 mm or more, such as 0.5 mm or more, or 1 mm or more, or 2 mm or more, or 3 mm or more, or 4 mm or more, or 5 mm or more, or 6 mm or more, or 7 mm or more, or 8 mm or more, or 9 mm or more, or 10 mm or more, or 12 mm or more, or 14 mm or more, or 16 mm or more, or 18 mm or more, or 20 mm or more, or 25 mm or more or 30 mm or more, or 35 mm or more, or 40 mm or more, or 50 mm or more, or 60 mm or more, or mm or more, or 80 mm or more, or 90 mm or more, or 100 mm or more, or 110 mm or more, or 120 mm or more, or 130 mm or more, or 140 mm or more, or 150 mm or more, or 160 mm or more, or 170 mm, or more, or 180 mm or more, or 190 mm or more, or 200 mm or more. For example, the distance between a dried reagent composition on the inner surface of the wall of the liquid container and the bottom of the liquid container may range from 0.1 mm to 200 mm, such as from 0.1 mm to 190 mm, or 0.1 mm to 180 mm, or 0.1 mm to 170 mm, or 0.1 mm to 160 mm, or 0.1 mm to 150 mm, or 0.1 mm to 140 mm, or 0.1 mm to 130 mm, or 0.1 mm to 120 mm, or 0.1 mm to 110 mm, or 0.1 mm to 100 mm, or 0.1 mm to 90 mm, or 0.1 mm to 80 mm, or 0.1 mm to 70 mm, or 0.1 mm to 60 mm, or 0.1 mm to 50 mm, or 0.1 mm to 40 mm, or 0.1 mm to 30 mm, or 0.1 mm to 20 mm, or 0.1 mm to 10 mm, or 0.1 mm to 9 mm, or 0.1 mm to 8 mm, or 0.1 mm to 7 mm, or 0.1 mm to 6 mm, or 0.1 mm to 5 mm, or 0.1 mm to 4 mm, or 0.1 mm to 3 mm, or 0.1 mm to 2 mm, or 0.1 mm to 1 mm, or mm to 0.5 mm. In certain instances, the distance between a dried reagent composition on the inner surface of the wall of the liquid container and the bottom of the liquid container ranges from 0.1 mm to 200 mm. In some cases, the distance between a dried reagent composition on the inner surface of the wall of the liquid container and the bottom of the liquid container ranges from 0.1 mm to 10 mm.

In some instances, distinctly positioned dried reagent compositions are spaced apart from each other at separate locations on the surface of the liquid container. A dried reagent composition that is spaced apart from another dried reagent composition may be physically separated from adjacent dried reagent compositions. For instance, distinctly positioned dried reagent compositions may be positioned on the surface of the liquid container at separate locations such that there is a certain distance between an edge of the dried reagent composition and an edge of an adjacent dried reagent composition. In some embodiments, the distance between the separate locations of the dried reagent compositions on the surface of the liquid container is 0.1 mm or more, such as 0.5 mm or more, or 1 mm or more, or 2 mm or more, or 3 mm or more, or 4 mm or more, or 5 mm or more, or 6 mm or more, or 7 mm or more, or 8 mm or more, or 9 mm or more, or 10 mm or more, or 12 mm or more, or 14 mm or more, or 16 mm or more, or 18 mm or more, or 20 mm or more, or 25 mm or more or 30 mm or more, or 35 mm or more, or 40 mm or more, or 50 mm or more, or mm or more, or 70 mm or more, or 80 mm or more, or 90 mm or more, or 100 mm or more, or 110 mm or more, or 120 mm or more, or 130 mm or more, or 140 mm or more, or 150 mm or more, or 160 mm or more, or 170 mm, or more, or 180 mm or more, or 190 mm or more, or 200 mm or more. For example, the distance between the separate locations of the dried reagent compositions on the surface of the liquid container may range from 0.1 mm to 200 mm, such as from 0.1 mm to 190 mm, or 0.1 mm to 180 mm, or 0.1 mm to 170 mm, or 0.1 mm to 160 mm, or 0.1 mm to 150 mm, or 0.1 mm to 140 mm, or 0.1 mm to 130 mm, or 0.1 mm to 120 mm, or 0.1 mm to 110 mm, or 0.1 mm to 100 mm, or 0.1 mm to 90 mm, or 0.1 mm to 80 mm, or 0.1 mm to 70 mm, or 0.1 mm to 60 mm, or 0.1 mm to 50 mm, or 0.1 mm to 40 mm, or 0.1 mm to 30 mm, or 0.1 mm to 20 mm, or 0.1 mm to 10 mm, or 0.1 mm to 9 mm, or 0.1 mm to 8 mm, or 0.1 mm to 7 mm, or 0.1 mm to 6 mm, or 0.1 mm to 5 mm, or 0.1 mm to 4 mm, or 0.1 mm to 3 mm, or 0.1 mm to 2 mm, or 0.1 mm to 1 mm, or 0.1 mm to 0.5 mm. In certain instances, the distance between the separate locations of the dried reagent compositions on the surface of the liquid container ranges from 0.1 mm to 200 mm. In some cases, the distance between the separate locations of the dried reagent compositions on the surface of the liquid container ranges from 0.1 mm to 10 mm.

In certain embodiments, distinctly positioned dried reagent compositions are positioned adjacent to each other on the inner surface of the wall of the liquid container, but are not spaced apart from each other. In these instances, an edge of a dried reagent composition may contact the edge of an adjacent dried reagent composition. For example, the volume of space occupied by a dried reagent composition may contact, but not significantly overlap with a volume of space occupied by another (adjacent) dried reagent composition. In these embodiments, adjacent dried reagent compositions may contact each other, but are not significantly mixed together, e.g., substantially no portion of the distinctly positioned dried reagent composition is mixed with a portion of another (adjacent) dried reagent composition.

Distinctly positioned dried reagent compositions may be present on the same surface of the liquid container (e.g., the inner surface of the wall of the liquid container) but may be disposed at different positions on or relative to the surface of the liquid container (e.g., the inner surface of the wall of the liquid container). For example, as described above, the liquid container may include an inner surface and an outer surface. In certain instances, the dried reagent compositions are positioned on a surface of the liquid container (e.g., the inner surface of the wall of the liquid container). In some cases, the dried reagent compositions are distinctly positioned on an inner surface of the liquid container (e.g., the inner surface of the wall of the liquid container).

Examples of distinctly positioned dried reagent compositions include embodiments where a dried reagent composition is disposed on a surface of a liquid container (e.g., the inner surface of the wall of the liquid container) at a certain location and another dried reagent composition is also disposed on the surface of the container at a different location. As such, the distinctly positioned dried reagent compositions may be positioned at separate locations on the surface of the liquid container. For example, embodiments of the containers may include first and second dried reagent compositions, where the first dried reagent composition is positioned at a certain location on the inner surface of the wall of the liquid container and the second dried reagent composition is positioned on the inner surface of the wall of the liquid container at a different location than the first dried reagent composition. As described above, the first and second dried reagent compositions may be spaced apart from each other such that there is a distance between the separate locations of the first and second dried reagent compositions on the surface of the liquid container (e.g., inner surface of the wall of the liquid container). The distance between the first and second dried reagent compositions may be according to the ranges and values as described above.

The dried reagent composition(s) may have any suitable dimensions. In some instances, the first and second dried reagent compositions have the same dimensions. In certain embodiments, the first and second dried reagent compositions include different dimensions. The dried reagent compositions may have any suitable cross-sectional shape including, e.g., rectilinear cross-sectional shapes, e.g., squares, rectangles, trapezoids, triangles, hexagons, etc., curvilinear cross-sectional shapes, e.g., circles, ovals, as well as irregular shapes, e.g., a parabolic shape. In some instances, the first and second dried reagent compositions have a diameter ranging from 0.01 mm to 5 mm including, e.g., from mm to 4 mm, from 0.01 mm to 3 mm, from 0.01 to 2 mm, from 0.01 to 1 mm, from 0.1 mm to 5 mm, from 0.1 mm to 4 mm, from 0.1 mm to 3 mm, from 0.1 to 2 mm, from 0.1 to 1 mm, from 0.5 mm to 5 mm, from 0.5 mm to 4 mm, from 0.5 mm to 3 mm, from 0.5 to 2 mm, from 0.5 to 1 mm. In some instances, the first and second dried reagent compositions include a surface area ranging from 5×10⁻⁵ mm² to 20 mm² including, e.g., 5×10⁻⁵ mm² to mm², 5×10⁻³ mm² to 20 mm², 0.1 mm² to 20 mm², 5×10⁻⁵ mm² to 0.5 mm², 5×10⁻³ mm² to 0.5 mm², 0.1 mm² to 0.5 mm².

Additional dried reagent compositions may be provided on the inner surface of the liquid container (e.g., inner surface of the wall of the liquid container). For example, the container may include a third dried reagent composition (e.g., dye composition) distinctly positioned on the inner surface of the wall of the liquid container. The third dried reagent composition may be distinctly positioned relative to the first dried reagent composition, and also may be distinctly positioned relative to the second dried reagent composition. As such, each of the dried reagent compositions (e.g., first, second and third dried reagent compositions) may be distinctly positioned relative to each other on the inner surface of the wall of the liquid container, as described herein. Additional distinctly positioned dried reagent compositions may be provided on the surface of the liquid container, such as 4 or more distinctly positioned dried reagent compositions, or 5 or more, 7 or more, 10 or more, etc., as described above. In some instances, the dried reagent compositions are adhered to the inner surface of the wall of the liquid container.

Additional examples of distinctly positioned dried reagent compositions include embodiments where a dried reagent composition is disposed on a surface of a liquid container (e.g., the inner surface of the wall of the liquid container) at a certain location and another dried reagent composition is located at the same location. As such, the distinctly positioned dried reagent compositions may be co-located at the same location of the surface of the liquid container (e.g., inner surface of the wall of the liquid container). Dried reagent compositions may be co-located at the same location yet still be distinctly positioned. For example, dried reagent compositions may be separated from each other by a non-dye material. In some cases, the non-dye material is interposed between distinctly positioned dried reagent compositions. The non-dye material may substantially cover a surface of a dried reagent composition such that an adjacent dried reagent composition is separated from the dried reagent composition. For instance, a dried reagent composition may have a non-dye material disposed over the surface of the dried reagent composition, and another dried reagent composition may be disposed on a surface of the non-dye material. In these instances, the dried reagent composition may be physically separated from other dried reagent compositions by the non-dye material. In some cases, the distinctly positioned dried reagent compositions may be provided as alternating layers of a dried reagent composition and a non-dye material on a surface of the container. As such, in certain embodiments, two or more dried reagent compositions are distinctly positioned relative to each other and are also co-located at the same location of the surface of the liquid container. In some embodiments, a non-dye material (e.g., a non-reagent material) may be positioned in the liquid container spaced apart from the distinctly positioned dried reagent compositions such that there is a distance between the non-dye material and the one or more dried reagent compositions.

In certain embodiments, the non-dye material is a material compatible with other assay components (e.g., reagents, buffers, analytes, etc.) that may be present in the liquid container during use. The non-dye material may be substantially inert with respect to the other assay components (e.g., reagents, buffers, analytes, etc.) that may be present in the container during use such that there is no significant reaction between the non-dye material and the other assay components. Examples of non-dye materials include, but are not limited to, any reagent as discussed above, non-reagent materials, stabilizers, buffers, soluble inert materials (e.g., aqueous soluble inert materials), beads, and the like. Stabilizers of interest include, but are not limited to: sugars and polyalcohols. Sugars and polyalcohols suitable for use in lyophilized dye compositions include sugars that are compatible with the other reagents, buffers, dyes and sample components being used. Examples of suitable sugars include, but are not limited to, sucrose, maltose, trehalose, 2-hydroxypropyl-beta-cyclodextrin (β-HPCD), lactose, glucose, fructose, galactose, glucosamine, and the like, and combinations thereof. In certain instances, the sugar is a disaccharide. For example, the disaccharide may be sucrose. Examples of suitable polyalcohols include, but are not limited to, mannitol, glycerol, erythritol, threitol, xylitol, sorbitol, and the like, and combinations thereof. Non-dye materials may include, for example, bovine serum albumin (BSA), sodium azide, glycerol, phenylmethanesulfonyl fluoride (PMSF), ethylenediaminetetraacetic acid (EDTA), buffered citrate, phosphate buffered saline (PBS), sodium chloride, paraformaldehyde, and the like, and combinations thereof.

For example, embodiments of the liquid containers may include first and second dried reagent compositions, where the first dried reagent composition is positioned at a certain location on the surface of the liquid container (e.g., the inner surface of the wall of the liquid container) and the second dried reagent composition is co-located at the same location as the first dried reagent composition. As described above, the first and second dried reagent compositions may be spaced apart from each other such that there is a distance between the first and second dried reagent compositions. For instance, the first and second dried reagent compositions may be separated from each other by a non-dye material, as described above. The distance between the first and second dried reagent compositions may be according to the ranges and values as described above. For example, the non-dye material may be interposed between the distinctly positioned first and second dried reagent compositions. In these embodiments, the first dried reagent composition may be positioned on a surface of the liquid container, the non-dye material may be disposed as a layer on a surface of the first dried reagent composition, and the second dried reagent composition may be disposed on the surface of the non-dye composition. In these instances, the first dried reagent composition may be physically separated from the second dried reagent compositions by the non-dye material. As such, in certain embodiments, the first and second dried reagent compositions are distinctly positioned relative to each other and are also co-located at the same location of the surface of the liquid container. For example, the layer of non-dye material on the surface of the first dried reagent composition may substantially cover the entire surface of the first dried reagent composition. In these instances, a second dried reagent composition disposed on the surface of the non-dye composition may not significantly contact the first dried reagent composition. In some cases, the non-dye material is a substantially contiguous layer of non-dye material on the surface of the first dried reagent composition. For example, the non-dye material may cover a substantial portion of the surface of the first dried reagent composition, such as 75% or more of the surface of the first dried reagent composition, or 80% or more, or 85% or more, or 90% or more, or 95% or more, or 97% or more, or 99% or more of the surface of the first dried reagent composition. Embodiments where the surface of the first dried reagent composition is substantially covered by the non-dye material may provide for a minimization in dye-dye interactions between the first and second dried reagent compositions.

In certain embodiments, the non-dye material has a thickness ranging from 0.01 mm to 5 mm, such as from 0.05 mm to 5 mm, or 0.1 mm to 5 mm, or 0.1 mm to 4 mm, or 0.1 mm to 3 mm, or 0.1 mm to 2 mm, or 0.1 mm to 1 mm, or 0.1 mm to 0.9 mm, or 0.1 mm to 0.8 mm, or 0.1 mm to 0.7 mm, or 0.1 mm to 0.6 mm, or 0.1 mm to 0.5 mm. In certain instances, the non-dye material has a thickness from 0.1 mm to 1 mm. In some cases, the non-dye material has a thickness from 0.1 mm to 0.05 mm.

Additional dried reagent compositions may also be provided. For example, the liquid container may include a third dried reagent composition distinctly positioned relative to the first and second dried reagent compositions. As such, the third dried reagent composition may be distinctly positioned relative to the first dried reagent composition, and also may be distinctly positioned relative to the second dried reagent composition. Thus, each of the dried reagent compositions (e.g., first, second and third dried reagent compositions) may be distinctly positioned relative to each other, as described herein. In some cases, each of the dried reagent compositions may be separated from each other by a non-dye material. For instance, each of the dried reagent compositions may be separated from each other by a non-dye material. In some cases, the non-dye material is interposed between each of the distinctly positioned dried reagent compositions. In certain instances, each of the distinctly positioned dried reagent compositions is provided as a layer with a layer of the non-dye material in between each of the distinctly positioned dried reagent compositions. Additional layers of distinctly positioned dried reagent compositions may be provided, such as 4 or more distinctly positioned dried reagent compositions, or 5 or more, 7 or more, 10 or more, etc., as described above. As such, a plurality of dried reagent compositions can be distinctly positioned relative to each other and also co-located at the same location of the surface of the liquid container (e.g., the inner surface of the wall of the liquid container).

In certain embodiments, the dried reagent compositions on the surface of the liquid container are dried dye compositions that, e.g., include a dye. A dried dye composition is a dye composition that includes a low amount of solvent. For example, dried dye compositions may include a low amount of a liquid, such as water. In some cases, a dried dye composition includes substantially no solvent. For instance, dried dye compositions may include substantially no liquid, such as water. In certain embodiments, a dried dye composition includes 25 wt % or less solvent, such as 20 wt % or less, or 15 wt % or less, or 10 wt % or less, or 5 wt % or less, or 3 wt % or less, or 1 wt % or less, or 0.5 wt % or less solvent. In some cases, a dried dye composition is not a fluid. In some cases, a dried dye composition is substantially a solid. For example, a dried dye composition may have a high viscosity, such as a viscosity of 10,000 cP or more, or 25,000 cP or more, or 50,000 cP or more, or 75,000 cP or more, or 100,000 cP or more, or 150,000 cP or more, or 200,000 cP or more, or 250,000 cP or more at standard conditions.

In some instances, the dye compositions are lyophilized dye compositions. In certain cases, a lyophilized dye composition is a dye composition where water has been removed from the dye composition by sublimation, where the water in the dye composition undergoes a phase transition from a solid to a gas. For example, a lyophilized dye composition may be a dye composition where water has been removed from the composition by freezing the dye composition (e.g., freezing water in the dye composition) and then reducing the pressure surrounding the dye composition such that the water in the dye composition undergoes sublimation. In certain instances, a lyophilized dye composition includes water in a low amount, such as 25% or less, or 20% or less, or 15% or less, or 10% or less, or 9% or less, or 8% or less, or 7% or less, or 6% or less, or 5% or less, or 4% or less, or 3% or less, or 2% or less, or 1% or less, or 0.5% or less, or 0.25% or less, or 0.1% or less water as measured by Karl Fischer (KF) titration. In some cases, a lyophilized dye composition has 3% or less water as measured by Karl Fischer titration. In some cases, a lyophilized dye composition has 1% or less water as measured by Karl Fischer titration. In some cases, a lyophilized dye composition has 0.5% or less water as measured by Karl Fischer titration. Lyophilized dye compositions may include additives and/or excipients, such as a stabilizer. In some cases, the lyophilized dye composition includes a stabilizer, such as a sugar or a polyalcohol. Sugars and polyalcohols suitable for use in lyophilized dye compositions include sugars that are compatible with the other reagents, buffers, dyes and sample components being used. Examples of suitable sugars include, but are not limited to, sucrose, maltose, trehalose, 2-hydroxypropyl-beta-cyclodextrin (6-HPCD), lactose, glucose, fructose, galactose, glucosamine, and the like, and combinations thereof. In certain instances, the sugar is a disaccharide. For example, the disaccharide may be sucrose. Examples of suitable polyalcohols include, but are not limited to, mannitol, glycerol, erythritol, threitol, xylitol, sorbitol, and the like, and combinations thereof.

The dye in the dye composition may be used as a detectable label. In certain cases, the dye includes detectable moieties or markers that are detectible based on, for example, fluorescence emission maxima, fluorescence polarization, fluorescence lifetime, light scatter, mass, molecular mass, or combinations thereof. In certain embodiments, the detectable label is a fluorophore (i.e., a fluorescent label, fluorescent dye, etc.). Fluorophores of interest may include, but are not limited to, dyes suitable for use in analytical applications (e.g., flow cytometry, imaging, etc.).

In some instances, the fluorophore is polymeric dye. In some instances of the method, the polymeric dye includes a conjugated polymer. Conjugated polymers (CPs) are characterized by a delocalized electronic structure which includes a backbone of alternating unsaturated bonds (e.g., double and/or triple bonds) and saturated (e.g., single bonds) bonds, where 7-electrons can move from one bond to the other. As such, the conjugated backbone may impart an extended linear structure on the polymeric dye, with limited bond angles between repeat units of the polymer. For example, proteins and nucleic acids, although also polymeric, in some cases do not form extended-rod structures but rather fold into higher-order three-dimensional shapes. In addition, CPs may form “rigid-rod” polymer backbones and experience a limited twist (e.g., torsion) angle between monomer repeat units along the polymer backbone chain. In some instances, the polymeric dye includes a CP that has a rigid rod structure. The structural characteristics of the polymeric dyes can have an effect on the fluorescence properties of the molecules.

Polymeric dyes of interest include, but are not limited to, those dyes described by Gaylord et al. in U.S. Publication Nos. 20040142344, 20080293164, 20080064042, 20100136702, 20110256549, 20110257374, 20120028828, 20120252986, 20130190193, 20160264737, 20160266131, 20180231530, 20180009990, 20180009989, and 20180163054, the disclosures of which are herein incorporated by reference in their entirety; and Gaylord et al., J. Am. Chem. Soc., 2001, 123 (26), pp 6417-6418; Feng et al., Chem. Soc. Rev., 2010,39, 2411-2419; and Traina et al., J. Am. Chem. Soc., 2011, 133 (32), pp 12600-12607, the disclosures of which are herein incorporated by reference in their entirety.

The polymeric dye may have one or more desirable spectroscopic properties, such as a particular absorption maximum wavelength, a particular emission maximum wavelength, extinction coefficient, quantum yield, and the like (see e.g., Chattopadhyay et al., “Brilliant violet fluorophores: A new class of ultrabright fluorescent compounds for immunofluorescence experiments.” Cytometry Part A, 81A(6), 456-466, 2012). In some embodiments, the polymeric dye has an absorption curve between 280 nm and 475 nm. In certain embodiments, the polymeric dye has an absorption maximum (excitation maximum) in the range 280 nm and 475 nm. In some embodiments, the polymeric dye absorbs incident light having a wavelength in the range between 280 nm and 475 nm. In some embodiments, the polymeric dye has an emission maximum wavelength ranging from 400 nm to 850 nm, such as 415 nm to 800 nm, where specific examples of emission maxima of interest include, but are not limited to: 421 nm, 510 nm, 570 nm, 602 nm, 650 nm, 711 nm and 786 nm. In some instances, the polymeric dye has an emission maximum wavelength in a range selected from the group consisting of 410 nm to 430 nm, 500 nm to 520 nm, 560 nm to 580 nm, 590 nm to 610 nm, 640 nm to 660 nm, 700 nm to 720 nm, and 775 nm to 795 nm. In certain embodiments, the polymeric dye has an emission maximum wavelength of 421 nm. In some instances, the polymeric dye has an emission maximum wavelength of 510 nm. In some cases, the polymeric dye has an emission maximum wavelength of 570 nm. In certain embodiments, the polymeric dye has an emission maximum wavelength of 602 nm. In some instances, the polymeric dye has an emission maximum wavelength of 650 nm. In certain cases, the polymeric dye has an emission maximum wavelength of 711 nm. In some embodiments, the polymeric dye has an emission maximum wavelength of 786 nm. In certain instances, the polymeric dye has an emission maximum wavelength of 421 nm±5 nm. In some embodiments, the polymeric dye has an emission maximum wavelength of 510 nm±5 nm. In certain instances, the polymeric dye has an emission maximum wavelength of 570 nm±5 nm. In some instances, the polymeric dye has an emission maximum wavelength of 602 nm±5 nm. In some embodiments, the polymeric dye has an emission maximum wavelength of 650 nm±5 nm. In certain instances, the polymeric dye has an emission maximum wavelength of 711 nm±5 nm. In some cases, the polymeric dye has an emission maximum wavelength of 786 nm±5 nm. In certain embodiments, the polymeric dye has an emission maximum selected from the group consisting of 421 nm, 510 nm, 570 nm, 602 nm, 650 nm, 711 nm and 786 nm.

Specific polymeric dyes that may be employed include, but are not limited to, BD Horizon Brilliant™ Dyes, such as BD Horizon Brilliant™ Violet Dyes (e.g., BV421, BV480, BV510, BV570, BV605, BV650, BV711, BV750, BV786); BD Horizon Brilliant™ Ultraviolet Dyes (e.g., BUV395, BUV496, BUV563, BUV615, BUV661, BUV737, BUV805); and BD Horizon Brilliant™ Blue Dyes (e.g., BB515, BB630-P2, BB660-P2, BB700, BB755-P, BB-790P) (BD Biosciences, San Jose, CA).

In certain embodiments, as described above, the liquid container (e.g., the inner surface of the wall of the liquid container) includes more than one dye composition, such as, for example, two dye compositions (e.g., first and second dye compositions). In these embodiments, the dye compositions can be polymeric dye compositions, as described above. For example, the liquid container may include first and second polymeric dye compositions. As described above, the first and second polymeric dyes may be conjugated polymers (CPs). In certain cases, the first and second polymeric dyes are water soluble conjugated polymers, as described above. In some instance, the dye compositions included in the liquid container may be different dye compositions, such as different polymeric dye compositions. Different dye compositions may differ from each other in terms of chemical composition and/or in terms of one or more properties of the dyes. For instance, different dye compositions may differ from each other by at least one of excitation maxima and emission maxima. In some cases, different dye compositions differ from each other by their excitation maxima. In some cases, different dye compositions differ from each other by their emission maxima. In some cases, different dye compositions differ from each other by both their excitation maxima and emission maxima. As such, in embodiments that include first and second dyes, the first and second dyes may differ from each other by at least one of excitation maxima and emission maxima. For example, the first and second dyes may differ from each other by excitation maxima, by emission maxima, or by both excitation and emission maxima. Additional dye compositions may be included in the liquid container, where each of the dye compositions in the container differ from each other as described above.

In certain embodiments, the liquid container (e.g., the inner surface of the wall of the liquid container) also includes other types of dye compositions, such as one or more non-polymeric dye compositions. As discussed above, dyes may include detectable moieties or markers that are detectible based on, for example, fluorescence emission maxima, fluorescence polarization, fluorescence lifetime, light scatter, mass, molecular mass, or combinations thereof. In certain embodiments, the non-polymeric dye includes a fluorophore (i.e., a fluorescent label, fluorescent dye, etc.). Fluorophores of interest may include but are not limited to dyes suitable for use in analytical applications (e.g., flow cytometry, imaging, etc.). A large number of non-polymeric dyes are commercially available from a variety of sources, such as, for example, Molecular Probes (Eugene, OR) and Exciton (Dayton, OH). For example, the fluorophore of the non-polymeric dye may be 4-acetamido-4′-isothiocyanatostilbene-2,2′disulfonic acid; acridine and derivatives such as acridine, acridine orange, acrindine yellow, acridine red, and acridine isothiocyanate; 5-(2′-aminoethyl)aminonaphthalene-1-sulfonic acid (EDANS); 4-amino-N-[3-vinylsulfonyl)phenyl]naphthalimide-3,5 disulfonate (Lucifer Yellow VS); N-(4-anilino-1-naphthyl)maleimide; anthranilamide; Brilliant Yellow; coumarin and derivatives such as coumarin, 7-amino-4-methylcoumarin (AMC, Coumarin 120), 7-amino-4-trifluoromethylcouluarin (Coumaran 151); cyanine and derivatives such as cyanosine, Cy3, Cy3.5, Cy5, Cy5.5, and Cy7; 4′,6-diaminidino-2-phenylindole (DAPI); 5′, 5″-dibromopyrogallol-sulfonephthalein (Bromopyrogallol Red); 7-diethylamino-3-(4′-isothiocyanatophenyl)-4-methylcoumarin; diethylaminocoumarin; diethylenetriamine pentaacetate; 4,4′-diisothiocyanatodihydro-stilbene-2,2′-disulfonic acid; 4,4′-diisothiocyanatostilbene-2,2′-disulfonic acid; 5-[dimethylamino]naphthalene-1-sulfonyl chloride (DNS, dansyl chloride); 4-(4′-dimethylaminophenylazo)benzoic acid (DABCYL); 4-dimethylaminophenylazophenyl-4′-isothiocyanate (DABITC); eosin and derivatives such as eosin and eosin isothiocyanate; erythrosin and derivatives such as erythrosin B and erythrosin isothiocyanate; ethidium; fluorescein and derivatives such as 5-carboxyfluorescein (FAM), 5-(4,6-dichlorotriazin-2-yl)aminofluorescein (DTAF), 2′7′-dimethoxy-4′5′-dichloro-6-carboxyfluorescein (JOE), fluorescein isothiocyanate (FITC), fluorescein chlorotriazinyl, naphthofluorescein, and QFITC (XRITC); fluorescamine; IR144; IR1446; Green Fluorescent Protein (GFP); Reef Coral Fluorescent Protein (RCFP); Lissamine™; Lissamine rhodamine, Lucifer yellow; Malachite Green isothiocyanate; 4-methylumbelliferone; ortho cresolphthalein; nitrotyrosine; pararosaniline; Nile Red; Oregon Green; Phenol Red; B-phycoerythrin (PE); o-phthaldialdehyde; pyrene and derivatives such as pyrene, pyrene butyrate and succinimidyl 1-pyrene butyrate; Reactive Red 4 (Cibacron™ Brilliant Red 3B-A); rhodamine and derivatives such as 6-carboxy-X-rhodamine (ROX), 6-carboxyrhodamine (R6G), 4,7-dichlororhodamine lissamine, rhodamine B sulfonyl chloride, rhodamine (Rhod), rhodamine B, rhodamine 123, rhodamine X isothiocyanate, sulforhodamine B, sulforhodamine 101, sulfonyl chloride derivative of sulforhodamine 101 (Texas Red), N,N,N′,NAetramethyl-6-carboxyrhodamine (TAMRA), tetramethyl rhodamine, and tetramethyl rhodamine isothiocyanate (TRITC); riboflavin; rosolic acid and terbium chelate derivatives; xanthene; carotenoid-protein complexes, such as peridinin-chlorophyll proteins (PerCP); allophycocyanin (APC); or combinations thereof.

In certain embodiments, the dye compositions included in the liquid container (e.g., the inner surface of the wall of the liquid container) include polymeric dye compositions, as described above. In some cases, the dye compositions included in the liquid container include non-polymeric dye compositions, as described above. In some instances, the dye compositions included in the liquid container include both polymeric dye compositions and non-polymeric dye compositions. As described above, each of the dye compositions (e.g., polymeric and non-polymeric dye compositions) may be distinctly positioned on a surface of the liquid container. In some cases, the liquid container includes a plurality of dye compositions as described above. For example, the liquid container may include two or more, such as three or more, distinct polymeric dye compositions and two or more, such as three or more, or four or more, or five or more, distinct non-polymeric dye compositions. In some cases, the liquid container includes three or more distinct polymeric dye compositions and five or more distinct non-polymeric dye compositions.

As described above, the liquid container may include both a polymeric dye composition and a non-polymeric dye composition. In some instances, a polymeric dye composition is mixed with a non-polymeric dye composition. In certain embodiments, the mixture of the polymeric dye composition and the non-polymeric dye composition do not undergo significant dye-dye interactions between the polymeric dye composition and the non-polymeric dye composition. For instance, the fluorescence emission energy of the polymeric dye composition is not significantly quenched by interactions with the non-polymeric dye composition. In some cases, the fluorescence emission energy of the polymeric dye composition is not significantly dissipated by a non-radiative transition. In these embodiments, the detectable fluorescence of the polymeric dye composition is not significantly less than would be expected as compared to the fluorescence of the polymeric dye composition in the absence of the non-polymeric dye composition. Similarly, in some embodiments, the fluorescence emission energy of the non-polymeric dye composition is not significantly quenched by interactions with the polymeric dye composition. For instance, the fluorescence emission energy of the non-polymeric dye composition may not be significantly dissipated by a non-radiative transition. In these embodiments, the detectable fluorescence of the non-polymeric dye composition is not significantly less than would be expected as compared to the fluorescence of the non-polymeric dye composition in the absence of the polymeric dye composition.

In certain embodiments, the dye composition includes a dye, such as a polymeric and/or non-polymeric dye, as described above. The dye composition may also include other components, such as, but not limited to a solvent, a buffer, a stabilizer, and the like. For example, the dye composition may include a stabilizer that reduces and/or substantially prevents degradation of the dye in the dye composition. In some cases, the presence of a stabilizer in the dye composition is sufficient to reduce and/or substantially prevent degradation of the dye in the dye composition for a certain period of time, such as 24 hours or more, or 48 hours or more, or 72 hours or more, or 4 days or more, or 5 days or more, or 6 days or more, or 1 week or more, or 2 weeks or more, or 3 weeks or more, or 4 weeks or more, or 2 months or more, or 3 months or more, or 4 months or more, or 5 months or more, or 6 months or more, or 9 months or more, or 1 year or more. Examples of stabilizers include, but are not limited to, bovine serum albumin (BSA), sodium azide, glycerol, phenylmethanesulfonyl fluoride (PMSF), and the like. Additional additives may also be present in the composition, such as, additives that preserve cells present in whole blood, e.g., platelet stabilizing factor, and the like. Examples of additives that may be included in the composition are anticoagulants such as ethylenediaminetetraacetic acid (EDTA), buffered citrate, heparin, and the like. The composition may include these additives in a liquid or dried state.

In some instances, the dye component of a given dried dye composition is a conjugate of a dye moiety and a specific binding member. The specific binding member and the dye moiety can be conjugated (e.g., covalently linked) to each other at any convenient locations of the two molecules, via an optional linker.

As used herein, the term “specific binding member” refers to one member of a pair of molecules which have binding specificity for one another. One member of the pair of molecules may have an area on its surface, or a cavity, which specifically binds to an area on the surface of, or a cavity in, the other member of the pair of molecules. Thus the members of the pair have the property of binding specifically to each other to produce a binding complex. In some embodiments, the affinity between specific binding members in a binding complex is characterized by a K_{d} (dissociation constant) of 10⁻⁶ M or less, such as 10⁻⁷ M or less, including 10⁻⁸ M or less, e.g., 10⁻⁹ M or less, 10⁻¹⁰ M or less, 10⁻¹¹ M or less, 10⁻¹² M or less, 10⁻¹³ M or less, 10⁻¹⁴ M or less, including 10⁻¹⁵ M or less. In some embodiments, the specific binding members specifically bind with high avidity. By high avidity is meant that the binding member specifically binds with an apparent affinity characterized by an apparent K_{d} of 10×10⁻⁹ M or less, such as 1×10⁻⁹ M or less, 3×10⁻¹⁰ M or less, 1×10⁻¹⁰ M or less, 3×10⁻¹¹ M or less, 1×10⁻¹¹ M or less, 3×10⁻¹² M or less or 1×10⁻¹² M or less.

The specific binding member can be proteinaceous. As used herein, the term “proteinaceous” refers to a moiety that is composed of amino acid residues. A proteinaceous moiety can be a polypeptide. In certain cases, the proteinaceous specific binding member is an antibody. In certain embodiments, the proteinaceous specific binding member is an antibody fragment, e.g., a binding fragment of an antibody that specific binds to a polymeric dye. As used herein, the terms “antibody” and “antibody molecule” are used interchangeably and refer to a protein consisting of one or more polypeptides substantially encoded by all or part of the recognized immunoglobulin genes. The recognized immunoglobulin genes, for example in humans, include the kappa (k), lambda (l), and heavy chain genetic loci, which together include the myriad variable region genes, and the constant region genes mu (u), delta (d), gamma (g), sigma (e), and alpha (a) which encode the IgM, IgD, IgG, IgE, and IgA isotypes respectively. An immunoglobulin light or heavy chain variable region consists of a “framework” region (FR) interrupted by three hypervariable regions, also called “complementarity determining regions” or “CDRs”. The extent of the framework region and CDRs have been precisely defined (see, “Sequences of Proteins of Immunological Interest,” E. Kabat et al., U.S. Department of Health and Human Services, (1991)). The numbering of all antibody amino acid sequences discussed herein conforms to the Kabat system. The sequences of the framework regions of different light or heavy chains are relatively conserved within a species. The framework region of an antibody, that is the combined framework regions of the constituent light and heavy chains, serves to position and align the CDRs. The CDRs are primarily responsible for binding to an epitope of an antigen. The term antibody is meant to include full length antibodies and may refer to a natural antibody from any organism, an engineered antibody, or an antibody generated recombinantly for experimental, therapeutic, or other purposes as further defined below.

Antibody fragments of interest include, but are not limited to, Fab, Fab′, F(ab′)2, Fv, scFv, or other antigen-binding subsequences of antibodies, either produced by the modification of whole antibodies or those synthesized de novo using recombinant DNA technologies. Antibodies may be monoclonal or polyclonal and may have other specific activities on cells (e.g., antagonists, agonists, neutralizing, inhibitory, or stimulatory antibodies). It is understood that the antibodies may have additional conservative amino acid substitutions which have substantially no effect on antigen binding or other antibody functions.

In certain embodiments, the specific binding member is a Fab fragment, a F(ab′)2 fragment, a scFv, a diabody or a triabody. In certain embodiments, the specific binding member is an antibody. In some cases, the specific binding member is a murine antibody or binding fragment thereof. In certain instances, the specific binding member is a recombinant antibody or binding fragment thereof.

In certain embodiments, the liquid container also includes a calibration standard. The calibration standard may be useful for determining the accuracy of the assay and for ensuring consistency between subsequent assays. In some cases, the calibration standard includes a labelled bead, such as a fluorescently labelled bead. The fluorescently labelled bead may be a standard fluorescently labeled bead that is typically used as a calibration standard. Examples of standard fluorescently labeled beads include, but are not limited to, fluorescently labelled microparticles or nanoparticles. In some cases, the fluorescently labeled beads are configured such that they remain suspended in the assay mixture and do not substantially settle or aggregate. In some embodiments, the fluorescently labeled beads include, but are not limited to, fluorescently labelled polystyrene beads, fluorescein beads, rhodamine beads, and other beads tagged with a fluorescent dye. Additional examples of fluorescently labeled beads are described in U.S. Pat. Nos. 6,350,619; 7,738,094; and 8,248,597, the disclosures of each of which are herein incorporated by reference in their entirety.

In some cases, the liquid containers facilitate storage of the dye composition for an extended period of time. For instance, a liquid container may be a storage stable liquid container. In some cases, the dye compositions contained in the liquid container are storage stable dye compositions, where the dye compositions are substantially stable for an extended period of time. By “stable” or “storage stable” or “substantially stable” is meant a dye composition that does not significantly degrade and/or lose activity over an extended period of time. For example, a storage stable dye composition may not have significant loss of fluorescence activity due to degradation of the dye composition over an extended period of time, such as 10% or less loss of fluorescence activity, or 9% or less, or 8% or less, or 7% or less, or 6% or less, or 5% or less, or 4% or less, or 3% or less, or 2% or less, or 1% or less loss of fluorescence activity over an extended period of time. In certain instances, a storage stable dye composition has 5% or less loss of fluorescence activity over an extended period of time. In some cases, a storage stable dye composition substantially retains its fluorescence activity over an extended period of time, such as retains 100% of its activity, or 99% or more, or 98% or more, or 97% or more, or 96% or more, or 95% or more, or 94% or more, or 93% or more, or 92% or more, or 91% or more, or 90% or more, or 85% or more, or 80% or more, or 75% or more of its activity over an extended period of time. For example, a storage stable dye composition may retain 90% or more of its fluorescence activity over an extended period of time. In some cases, a storage stable composition retains 95% or more of its fluorescence activity over an extended period of time. An extended period of time is a period of time such as 1 week or more, or 2 weeks or more, or 3 weeks or more, or 1 month or more, or 2 months or more, or 3 months or more, or 4 months or more, or 6 months or more, or 9 months or more, or 1 year or more, or 1.5 years (e.g., 18 months) or more, or 2 years or more, or 2.5 years (e.g., 30 months) or more, or 3 years or more, or 3.5 years (e.g., 42 months) or more, or 4 years or more, or 4.5 years (e.g., 54 months) or more, or 5 years or more. For instance, an extended period of time may be 6 months or more. In some cases, an extended period of time is 9 months or more. In some cases, an extended period of time is 1 year (e.g., 12 months) or more. In some cases, an extended period of time is 1.5 years (e.g., 18 months) or more. In some cases, an extended period of time is 2 years (e.g., 24 months) or more. In some instances, the extended period of time is 10 years or less, such as 7.5 years or less, including 5 years or less, e.g., 2 years or less.

Various aspects of liquid containers (including the dried compositions, e.g., dried polymeric conjugated dye compositions) that may be part of systems of embodiments of the invention are further provided in U.S. Pat. No. 10,545,137 and 11,320,437, as well as United States Pending Application Publication No. 2020/0147615 A1 and pending U.S. application Ser. Nos. 17/580,130 and 17/830,070; the disclosures of which are herein incorporated by reference.

### Solid Volume Displacers

As summarized above, systems of the invention also include solid volume displacers. Solid volume displacers according to certain embodiments of the present disclosure are configured to be positioned inside of the liquid containers, e.g., as described above, to occupy a majority of the liquid container volume below the top of the dried reagent composition(s) positioned e.g., on the inner surface of the wall of the liquid container.

The solid volume displacer can be compatible with the liquid sample and/or reagent(s) or analyte(s) that may be in contact with the liquid container (e.g., contained inside of the liquid container). In some cases, the liquid sample may be an aqueous liquid sample, and in these cases, the solid volume displacer may be compatible with aqueous samples. By “compatible” is meant that the solid volume displacer (e.g., the material the solid volume displacer is made of) is substantially inert with respect to (e.g., does not significantly react with) the liquid and/or reagent(s) or analyte(s) in contact with the liquid container.

The solid volume displacer may include a first end and a second end and a body therebetween, the second end and the body configured to be positioned inside of the liquid containers as described above, e.g., such that the second end and the body displace a volume of liquid up the inner surface of the wall of the liquid container to reconstitute the dried reagent composition. For example, the second end and the body may be configured to be positioned inside of the liquid container such that the solid volume displacer occupies a majority of the liquid container volume below the top of the dried reagent composition. For instance, in some embodiments the second end and the body may be configured to be positioned inside of the liquid container such that the solid volume displacer occupies more than 50% of the liquid container volume below the top of the dried reagent composition. In certain instances, the second end and the body may be configured to be positioned inside of the liquid container such that the solid volume displacer occupies a portion of the liquid container volume below the top of the dried reagent composition, such as 55% or more, or 60% or more, or 70% or more, or 75% or more, or 80% or more, or 85% or more, or 90% or more, or 95% or more, or 99% or more of the volume. In embodiments where multiple dried reagent compositions are provided on an inner surface of the wall of the liquid container, the solid volume displacer may be configured to be positioned inside of the liquid container such that the solid volume displacer occupies a majority of the liquid container volume below the top of the dried reagent composition positioned furthest away from the bottom of the liquid container. In these instances, the solid volume displacer can be configured to displace a volume of liquid up the inner surface of the wall of the liquid container to reconstitute any and all dried reagent compositions present on the inner surface of the wall. In certain instances, the solid volume displacer is removable from the liquid container, such that after liquid in the liquid container is displaced in a manner sufficient to reconstitute the dried reagent composition or compositions, the solid volume displacer may be removed from the liquid container. In these instances, the removable solid volume displacer allows access to the reconstituted reagent composition or compositions. The reconstituted reagent composition or compositions may be collected for use in analytical applications (e.g., flow cytometry, imaging, etc.).

As described above, the liquid container may be configured to hold a certain volume of a fluid (e.g., gas or liquid). In certain embodiments, the liquid container is configured to hold a certain volume of a liquid below the top of the dried reagent composition. In these instances, there may be a volume of the liquid container below the top of the dried reagent composition that the solid volume displacer is not configured to occupy, e.g., such that introducing this volume of a liquid into the liquid container, when the solid volume displacer is positioned inside of the liquid container, would fill the liquid container to the top of the dried reagent composition. For example, in some instances the volume of the liquid container below the top of the dried reagent composition that the solid volume displacer is not configured to occupy (e.g., the volume of liquid required to fill the liquid container to the top of the dried reagent composition when the solid volume displacer is positioned inside of the liquid container) may be 5000 μl or less, 1000 μl or less, such as 500 μl or less, or 400 μl or less, or 350 μl or less, or 300 μl or less, or 250 μl or less, or 200 μl or less, or 150 μl or less, or 100 μl or less, or 50 μl or less, or 20 μl or less, or 10 μl or less, or 1 μl or less. In some embodiments, the liquid container includes a volume of liquid (e.g., a biological liquid sample) equal to or greater than the volume of the liquid container below the top of the dried reagent composition the solid volume displacer is not configured to occupy.

As described above, there may be a volume of the liquid container below the top of the dried reagent composition that the solid volume displacer is not configured to occupy e.g., when the solid volume displacer is positioned inside of the liquid container. In other words, there may be a volume of liquid required to fill the liquid container to the top of the dried reagent composition when the solid volume displacer is positioned inside of the liquid container. As such, the solid volume displacer may be configured to reduce the volume of liquid required to fill the liquid container to the top of the dried reagent composition e.g., to contact the dried reagent composition. For example, the solid volume displacer may be configured to reduce the volume of liquid required to fill the liquid container to the top of the dried regent composition by 50% or more, such as 60% or more, or 70% or more, or 80% or more, or 90% or more, or 95% or more.

In some embodiments, the solid volume displacer may be configured to reduce the volume of liquid required to contact the dried reagent composition of the liquid container when compared to other systems of moving liquid up the walls of a liquid container. In some embodiments, the solid volume displacer may be configured to reduce the volume of liquid required to contact the dried reagent composition when compared to using an agitator (e.g., a vortexer) alone (i.e., without the solid volume displacer). For example, the solid volume displacer may be configured to reduce the volume of liquid needed to contact the dried reagent composition as compared to using a vortexer by 50% or more, such as 60% or more, or 70% or more, or 80% or more, or 90% or more. In some embodiments, the solid volume displacer may be configured to attach to a mechanical mixer. For example, the first end of the solid volume displacer may be configured to attach to a mechanical mixer. In some embodiments, the first end of the solid volume displacer may be configured to attach to an agitator (e.g., a vortexer).

The shape of the solid volume displacer may vary and may depend on the use of the solid volume displacer. For example, as described herein, the solid volume displacer may be introduced into the liquid containers described above in a manner sufficient to displace a volume of liquid up the inner surface of the wall of the liquid container to reconstitute the dried reagent composition(s) described above. In these cases, the solid volume displacer may be configured in a shape that is compatible with positioning the solid volume displacer inside of the liquid container. For instance, in embodiments where the wall of the liquid container is in the shape of a cylinder the body of the solid volume displacer may be configured in the shape of a cylinder. In these embodiments, the solid volume displacer may include an outside surface that is concentric to the inner surface of the wall of the liquid container. In these instances, the outside surface of the solid volume displacer may have a diameter that is different than the diameter of the inner surface of the wall of the liquid container (e.g., a diameter that is smaller than the diameter of the inner surface of the wall of the liquid container). For example, the difference (i.e., clearance) between the diameter of the outside surface of the body of the solid volume displacer and the diameter of the inner surface of the wall of the liquid container may be 5 mm or less, such as 4 mm or less, or 3 mm or less, or 2 mm or less, or 1 mm or less, or 0.5 mm or less, or 0.2 mm or less, or 0.1 mm or less, or 0.05 mm or less, or 0.02 mm or less, or 0.01 mm or less. In some embodiments, the outside surface of the solid volume displacer may include multiple sections having different diameters or, e.g., the outside surface may be stepped. In embodiments where the wall of the liquid container is tapered, the outside surface of the body of the solid volume displacer may be tapered at the same or a similar angle. In embodiments where the bottom of the liquid container is rounded, the second end of the solid volume displacer may be rounded and concentric to the bottom of the liquid container. In some embodiments, the solid volume displacer may be configured as a pestle. In certain cases, the solid volume displacer is hollow.

As described above, the distance between a dried reagent composition on the inner surface of the wall of the liquid container and the bottom of the liquid container may vary. In some cases, the solid volume displacer may be configured to displace a volume of liquid a distance up the inner surface of the equal to or greater than the distance between a dried reagent composition on the inner surface of the wall of the liquid container and the bottom of the liquid container. For instance, the solid volume displacer may be configured to displace a volume of liquid 0.1 mm or more up the inner surface of the wall of the liquid container, such as 0.5 mm or more, or 1 mm or more, or 2 mm or more, or 3 mm or more, or 4 mm or more, or 5 mm or more, or 6 mm or more, or 7 mm or more, or 8 mm or more, or 9 mm or more, or 10 mm or more, or 12 mm or more, or 14 mm or more, or 16 mm or more, or 18 mm or more, or 20 mm or more, or 25 mm or more or 30 mm or more, or 35 mm or more, or 40 mm or more, or 50 mm or more, or 60 mm or more, or 70 mm or more, or 80 mm or more, or 90 mm or more, or 100 mm or more, or 110 mm or more, or 120 mm or more, or 130 mm or more, or 140 mm or more, or 150 mm or more, or 160 mm or more, or 170 mm, or more, or 180 mm or more, or 190 mm or more, or 200 mm or more.

As described above, embodiments of the solid volume displacer can be compatible with the liquid sample and/or reagent(s) or analyte(s) in contact with the liquid container (e.g., contained within the liquid container). Examples of suitable solid volume displacer materials include, but are not limited to, ceramics, metals (e.g., stainless steel, aluminum, anodized aluminum, titanium, copper, bronze, nickel, etc.), paper, glass, resins, and plastic. For example, the solid volume displacer may be composed of glass, such as, but not limited to, silicate glass, borosilicate glass, sodium borosilicate glass (e.g., PYREX™), fused quartz glass, fused silica glass, and the like. Other examples of suitable solid volume displacer materials include polymeric materials. The polymeric material may be a hydrophobic polymeric material. In some embodiments, the hydrophobic polymeric material may be a resin such as, but not limited to, urethane methacrylate (UMA), Somos® 9120, Somos® WaterShed XC 11122, and Somos® EvoLVe. In some cases, the hydrophobic polymeric material may be a plastic, such as, but not limited to, polystyrene, polypropylene, polymethylpentene, polytetrafluoroethylene (PTFE), perfluoroethers (PFE), fluorinated ethylene propylene (FEP), perfluoroalkoxy alkanes (PFA), polyethylene terephthalate (PET), polyethylene (PE), low-density polyethylene (LDPE), polyetheretherketone (PEEK), and the like. The material the solid volume displacer is composed of may be translucent/transparent, semi-transparent, and/or may be any color such as, e.g., grey, black, white, yellow, etc.

In some embodiments, as described above, the solid volume displacer includes a first end and a second end and a body therebetween, the second end and the body configured to be positioned inside of the liquid container. In some embodiments, the first end of the solid volume displacer may be configured to be positioned outside of the liquid container when the body and the second end of the solid volume displacer are positioned inside of the liquid container. In some instances, the first end of the solid volume displacer may include a flange. In some embodiments, the flange is configured to stop the second end of the solid volume displacer from contacting the bottom of the liquid container e.g., by contacting the open end on the liquid container. In other embodiments, the flange is configured to allow the second end of the solid volume displacer to contact the bottom of the liquid container. In some embodiments, the solid volume displacer may include a ring of filter media positioned around the outside of the body near the first end. In these instances, the ring of filter media can be configured to prevent the liquid from splashing out of the liquid container when the body of the solid volume displacer is positioned inside of the liquid container. For example, the ring of filter media may prevent the liquid from splashing out of the container by eliminating open space between the outside surface of the body of the solid volume displacer and the inside surface of the wall of the liquid container near the open end of the liquid container when the body of the solid volume displacer is positioned inside of the liquid container. In other instances, the ring of filter media may be configured to prevent the liquid from splashing out of the container by meeting or sliding over and outside the open end of the liquid container (e.g., while maintaining contact with the open end) when the body of the solid volume displacer is positioned inside of the liquid container.

In some embodiments, the solid volume displacer is configured to prevent aerosol or liquid spray generation during use (e.g., when the body of the solid volume displacer is inserted into and subsequently removed from the inside of the liquid container). In some cases, the ring of filter media of the displacer may allow air pressure to equalize between the inside and outside of the container when the body of the solid volume displacer is positioned inside of the liquid container. For example, the ring of filter media may be composed of a material that allows for the passage of air but impedes or prevents the passage of liquid such as, e.g., a fibrous or porous material. In some cases, the fibrous or porous material may be configured to selectively allow passage of certain components of a liquid but prevent passage of other components of a liquid. For example, the fibrous or porous material may be configured to allow passage of a liquid and various substances dissolved therein while preventing the passage of cells (e.g., mammalian and/or bacterial cells) and virions. In some embodiments, the flange of the displacer includes surface features to allow air pressure to equalize between the inside and outside of the container such as, e.g., protrusions or recesses on the surface of the flange where the flange is configured to contact the liquid container when the body of the solid volume displacer is positioned inside of the liquid container. In some embodiments, the second end of the solid volume displacer may include protrusions (e.g., a series of ribs) and/or recesses (e.g., concentric sections of reduced diameter) configured to prevent liquids from being ejected out of the opening of the liquid container during use of the displacer for, e.g., reconstituting dried reagent compositions as described in greater detail below.

In some embodiments, the first end of the solid volume displacer may include a handle. In some cases, the handle may include protrusions (e.g., ribs or bump) or may include a slip resistant material for enhanced user grip and/or control. In some embodiments, the solid volume displacer may include a handle and a flange (e.g., as discussed above). In other cases, the solid volume displacer may include only one of a handle or a flange. In some embodiments, the first end of the solid volume displacer is configured to seal the open end of the liquid container when the second end and the body of the solid volume displacer are positioned inside of the liquid container. That is, the first end of the solid volume displacer may substantially prevent the contents of the liquid container (e.g., liquid inside the liquid container) from exiting the liquid container. The first end of the solid volume displacer may also substantially prevent other substances from entering the liquid container. For example, the first end of the solid volume displacer may form a water-tight seal that substantially prevents liquids from entering or exiting the container or may form an air-tight seal that substantially prevents gases from entering or exiting the container. In some embodiments, the first end of the solid volume displacer may form a water-tight seal that substantially prevents liquids from entering or exiting the liquid container but allows for air to exit and enter the container in order to, e.g., allow air pressure to equalize and prevent aerosol generation as discussed above. In some instances, the first end of the solid volume displacer may form a removable seal. In some embodiments, the first end of the solid volume displacer includes a threaded or snap-on cap or other suitable sealing element that can be applied to the opening of the liquid container. For instance, the first end of the solid volume displacer may include a threaded cap that can be screwed over the opening of the liquid container when the second end and the body of the solid volume displacer are positioned inside of the liquid container.

In some embodiments, one or more components of the solid volume displacer may be adjustable or detachable. In some cases, the flange may be adjustable or detachable. For example, the flange may include a latch, or a clamp configured to allow a user to attach or detach the flange depending on, e.g., if contact between the second end of the solid volume displacer and the bottom of the liquid container is desired. In some cases, the latch or clamp may allow a user to adjust the position of the flange on the solid volume displacer depending on, e.g., the desired clearance between the second end of the solid volume displacer and the bottom of the liquid container. In some cases, the ring of filter media is removable. In some embodiments, the solid volume displacer may be washed and/or sterilized for subsequent use (e.g., with an autoclave) or may be discarded. As such, in some embodiments, solid volume displacers as described herein are disposable, such as after a single use.

As described above, the solid volume displacer may be configured to be positioned inside of the liquid containers described above to occupy a majority of the liquid container volume below the top. In some instances, the second end of the solid volume displacer has an outer surface. In some instances, the body of the solid volume displacer has an outer surface. In these embodiments, the outer surface of the body of the solid volume displacer faces the inner surface of the wall of the liquid container when the body of the solid volume displacer is positioned inside of the liquid container. The outer surface of the body of the solid volume displacer may be in contact with the contents of the liquid container.

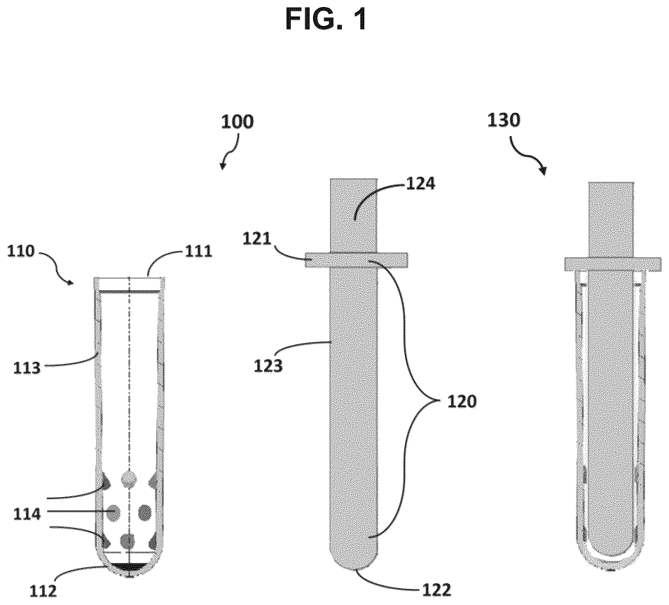

FIG. 1 provides a depiction of a system 100 in accordance with an embodiment of invention. The system 100 depicted in FIG. 1 is made up of two components, liquid container 110 and solid volume displacer 120. Liquid container 110 includes an open end 111 and a bottom 112 separated by a wall 113 therebetween. The inner surface of wall 113 includes dried reagent compositions 114 that may be polymeric dye compositions (e.g., conjugated polymeric dye compositions) or other dye or non-dye reagent compositions. Solid volume displacer 120 includes a first end 121 and a second end 122 and a body 123 therebetween.

The liquid container 110 is configured as a test tube or centrifuge tube with walls 113 in the shape of a cylinder and a rounded bottom 112. The dried reagent composition of dried reagent compositions 114 positioned furthest from the bottom of the liquid container 112 is approximately 20 mm from the bottom of the liquid container 112. The first end of the solid volume displacer 121 includes a flange that prevents the second end of the solid volume displacer 122 from contacting the bottom of the liquid container 112 and a handle 124 for increased usability/enhanced user grip. The body of the solid volume displacer 123 is configured as a cylinder with an outer surface that is concentric to the inner surface of the wall of the liquid container 113. The second end of the solid volume displacer 122 is rounded and concentric to the bottom of the liquid container 112. Assembly 130 provides a depiction of system 100 wherein the solid volume displacer is positioned inside of the liquid container.

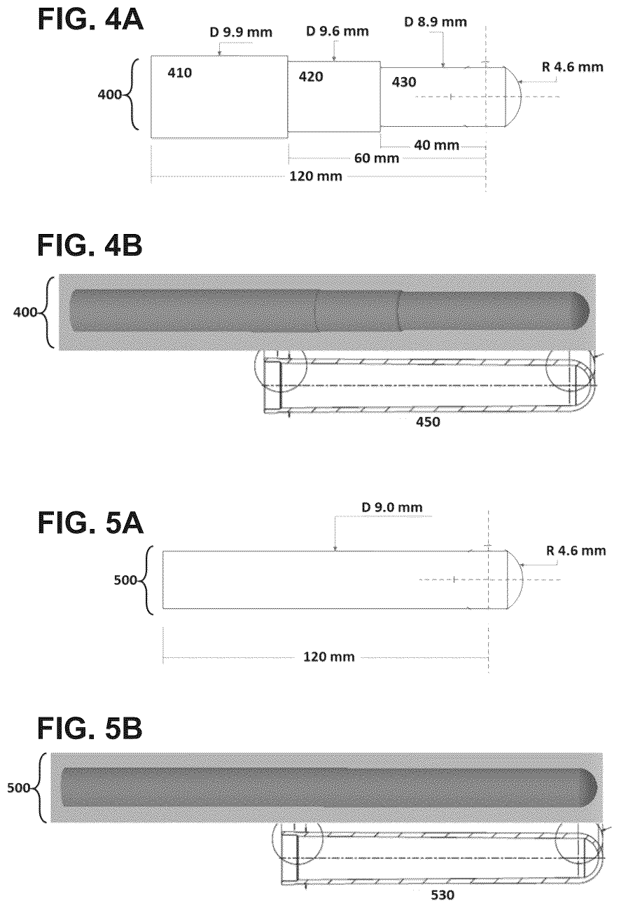

FIGS. 4A-4B provide a depiction of a stepped solid volume displacer in accordance with an embodiment of the invention. In FIG. 4A, a side view of solid volume displacer 400 is provided having cylindrical sections or steps 410, 420, and 430 of different diameters. Step 410, the step adjacent to the first end of solid volume displacer 400, is 60 mm long and has a diameter of 9.9 mm. Step 410 is configured to function as a handle when positioning displacer 400 into a liquid container. Step 420 is 20 mm long and has a diameter of 9.6 mm. Step 430, the step adjacent to the second end of solid volume displacer 400, is 40 mm long and has a diameter of 8.9 mm. The second end of solid volume 400 is a spherical cap having a hemisphere of radius of 4.6 mm wherein sections of the hemisphere protruding outside of step 430 are instead configured as a continuation of step 430. In FIG. 4B, a three-dimensional rendering of solid volume displacer 400 is provided adjacent to a sliced view of a liquid container 450 compatible with the displacer. In some cases, liquid container 450 is approximately 75.5 mm long with a tapered cylindrical section and a 1.0 mm thick hemispherical bottom. As such, when the second end of solid volume displacer 400 contacts the bottom of container 450, the open end of the container is approximately 69.9 mm from the center point of the spherical cap of the displacer (i.e., the extreme end of the second end of the displacer). In some cases, the clearance between the diameter of the outside surface of solid volume displacer 400 and the diameter of the inner surface of liquid container 450 may be approximately 0.2 mm near the bottom of container 450 when the second end of the displacer is in contact with the bottom of the container. The section of solid volume displacer 400 extending outside of container 450 when the second end of the displacer is in contact with the bottom of the container is configured as a handle.

FIGS. 5A-5B provide a depiction of a straight (i.e., non-stepped) solid volume displacer in accordance with an embodiment of the invention. In FIG. 5A, a side view of solid volume displacer 500 is provided having a first end, a single cylindrical section of length 120 mm and diameter 9.0 mm, and a spherical cap. The spherical cap is a hemisphere of radius of 4.6 mm wherein sections of the hemisphere protruding outside of the cylindrical section (i.e., of diameter 9.0 mm) are instead configured as a continuation of the cylindrical section. In FIG. 5B, a three-dimensional rendering of solid volume displacer 500 is provided adjacent to a sliced view of a liquid container 530 compatible with the displacer. In some cases, liquid container 530 is approximately 75.5 mm long with a tapered cylindrical section and a 1.0 mm thick hemispherical bottom. As such, when the second end of solid volume displacer 500 contacts the bottom of container 530, the open end of the container is approximately 69.9 mm from the center point of the spherical cap of the displacer (i.e., the extreme end of the second end of the displacer). In some cases, the clearance between the diameter of the outside surface of solid volume displacer 500 and the diameter of the inner surface of liquid container 530 may be approximately 0.1 mm near the bottom of container 530 when the second end of the displacer is in contact with the bottom of the container. The section of solid volume displacer 500 extending outside of container 530 when the second end of the displacer is in contact with the bottom of the container is configured as a handle.

### Methods of Use

As summarized above, aspects of the present disclosure also include methods of using the subject systems for reconstituting dried reagent compositions. As described above, the systems for reconstituting dried reagent compositions may include one or more dried reagent compositions (e.g., first and second polymeric dye compositions) distinctly positioned on a surface of the liquid container (e.g., the inner surface of the wall of the liquid container) and a solid volume displacer configured to be positioned inside of the liquid container to occupy a majority of the liquid container volume below the top of the dried reagent compositions. As such, the method of using the subject systems may include reconstituting the dried reagent composition(s). In some instances, the dried reagent compositions are dye compositions, e.g., polymeric dye compositions. The polymeric dye compositions may be dried polymeric dye compositions. As such, the method of using the systems may include reconstituting the dye compositions. In certain embodiments, the method includes introducing a volume of liquid into the liquid container followed by introducing the solid volume displacer into the liquid container in a manner sufficient to displace the liquid up the inner surface of the wall of the liquid container to reconstitute the dried reagent composition. The volume of liquid may be added to the container using any convenient liquid handling apparatus, such as, but not limited to, syringes, needles, pipets, aspirators, among other liquid handling devices.

In practicing embodiments of the subject methods, the methods may include introducing a volume of a liquid into the liquid container, the liquid container including: an open end and a bottom separated by a wall therebetween, wherein an inner surface of the wall includes a dried reagent composition and introducing the solid volume displacer into the liquid container in a manner sufficient to displace the liquid up the inner surface of the wall of the liquid container to reconstitute the dried reagent composition. In practicing embodiments of the subject methods, the methods may include mixing the liquid and the dried reagent composition by moving the solid volume displacer. In these instances, the movement may include rotating and/or reciprocating the solid volume displacer. In practicing some embodiments of the subject methods, the movement may include rotating the solid volume displacer. In practicing some embodiments of the subject methods, the movement may include reciprocating the solid volume displacer.

In certain embodiments, the liquid includes a biological sample. In some cases, the biological sample may be derived from specific biological fluids, such as, but not limited to, blood, mucus, lymphatic fluid, synovial fluid, cerebrospinal fluid, saliva, bronchoalveolar lavage, amniotic fluid, amniotic cord blood, urine, vaginal fluid and semen. In some embodiments, the biological sample includes whole blood or a fraction thereof. In some embodiments, the biological sample includes blood plasma.

In certain embodiments, the liquid container is a sealed container (e.g., the liquid container is sealed), such as where the container includes a seal (e.g., a water-tight and/or air-tight seal). In these instances, the method may include removing the seal prior to positioning or introducing the volume of liquid inside the liquid container. Removing the seal on the liquid container may expose the contents of the liquid container to the surrounding environment and allow access to the interior volume of the liquid container. Thus, a user that has access to the interior volume of the liquid container may position the volume of liquid inside the liquid container for reconstitution of the dried polymeric dye compositions inside the liquid container (e.g., by introducing the solid volume displacer into the liquid container in a manner sufficient to displace the liquid up the inner surface of the wall of the liquid container to reconstitute the dried reagent composition). In practicing some embodiments of the subject methods, the method may include sealing the liquid container after all dried reagent compositions have been reconstituted. In certain embodiments, the seal may be a removable cap. In these instances, the method may include removing the seal prior to positioning or introducing the volume of liquid inside the liquid container and re-sealing the liquid container after all dried reagent compositions have been reconstituted.

In certain embodiments, the solid volume displacer may include a first end and a second end and a body therebetween. In certain embodiments, the first end of the solid volume displacer is configured to attach to a mechanical mixer. In practicing some embodiments of the subject methods, the methods may include mixing the contents of the liquid container after positioning the solid volume displacer inside the liquid container (e.g., by attaching the first end of the solid volume displacer to a mechanical mixer). The mixing may be performed using any convenient protocol. For example, the mixing may be performed using an agitator. The agitator may be any convenient agitator sufficient for mixing the liquid inside the liquid container, including, but not limited to, vortexers, sonicators, shakers (e.g., manual, mechanical, or electrically powered shakers), rockers, oscillating plates, magnetic stirrers, static mixers, rotators, blenders, mixers, tumblers, orbital shakers, among other agitating protocols. In practicing some embodiments of the subject methods, reconstituting the dried reagent composition using the solid volume displacer includes introducing a smaller volume of liquid when compared to using an agitator (e.g., a vortexer) alone (i.e., without the solid volume displacer). For example, reconstituting the dried reagent composition using the solid volume displacer as compared to using a vortexer alone, e.g., without the solid volume displacer reduces the volume of liquid required to be introduced into the liquid container by 50% or more, such as 60% or more, or 70% or more, or 80% or more, or 90% or more. In practicing some embodiments of the subject methods, reconstituting the dried reagent composition using the vortexer with the solid volume displacer includes introducing a smaller volume of liquid when compared to using the solid volume displacer alone (i.e., without the vortexer).

In some cases, the method also includes assaying the reconstituted composition, e.g., reconstituted dye composition. Assaying the reconstituted composition, e.g., reconstituted dye composition, may be performed using any suitable assay apparatus. For example, the assay apparatus may be a flow cytometer. In these embodiments, the assaying includes flow cytometrically analyzing the reconstituted composition, e.g., reconstituted dye composition. In some instances, the assaying includes contacting the reconstituted composition, e.g., reconstituted dye composition, with electromagnetic radiation (e.g., light), such as electromagnetic radiation having a wavelength that corresponds to the excitation maxima of the reconstituted composition, e.g., reconstituted dye composition. The assaying may further include detecting emitted light from the excited reagent compositions, e.g., dye compositions. For instance, the method may include detecting emitted light from the excited reagent compositions, e.g., dye compositions, at one or more wavelengths that correspond to the emission maxima of the reagent compositions, e.g., dye compositions.

Suitable flow cytometry systems may include, but are not limited to those described in Ormerod (ed.), Flow Cytometry: A Practical Approach, Oxford Univ. Press (1997); Jaroszeski et al. (eds.), Flow Cytometry Protocols, Methods in Molecular Biology No. 91, Humana Press (1997); Practical Flow Cytometry, 3rd ed., Wiley-Liss (1995); Virgo, et al. (2012) Ann Clin Biochem. Jan;49(pt 1):17-28; Linden, et. al., Semin Throm Hemost. 2004 Oct;30(5):502-11; Alison, et al. J Pathol, 2010 Dec; 222(4):335-344; and Herbig, et al. (2007) Crit Rev Ther Drug Carrier Syst. 24(3):203-255; the disclosures of which are incorporated herein by reference. In certain instances, flow cytometry systems of interest include BD Biosciences FACSCanto™ II flow cytometer, BD Accuri™ flow cytometer, BD Biosciences FACSCelesta™ flow cytometer, BD Biosciences FACSLyric™ flow cytometer, BD Biosciences FACSVerse™ flow cytometer, BD Biosciences FACSymphony™ flow cytometer BD Biosciences LSRFortessa™ flow cytometer, BD Biosciences LSRFortess™ X-20 flow cytometer and BD Biosciences FACSCalibur™ cell sorter, a BD Biosciences FACSCount™ cell sorter, BD Biosciences FACSLyric™ cell sorter and BD Biosciences Via™ cell sorter BD Biosciences Influx™ cell sorter, BD Biosciences Jazz™ cell sorter, BD Biosciences Aria™ cell sorters and BD Biosciences FACSMelody™ cell sorter, or the like.

In certain embodiments, the subject flow cytometric systems are configured to sort one or more of the particles (e.g., cells) of the sample. The term “sorting” is used herein in its conventional sense to refer to separating components (e.g., cells, non-cellular particles such as biological macromolecules) of the sample and in some instances delivering the separated components to one or more sample collection containers. For example, the subject systems may be configured for sorting samples having 2 or more components, such as 3 or more components, such as 4 or more components, such as 5 or more components, such as 10 or more components, such as 15 or more components and including soring a sample having 25 or more components. One or more of the sample components may be separated from the sample and delivered to a sample collection container, such as 2 or more sample components, such as 3 or more sample components, such as 4 or more sample components, such as 5 or more sample components, such as 10 or more sample components and including 15 or more sample components may be separated from the sample and delivered to a sample collection container.

In some embodiments, particle sorting systems of interest are configured to sort particles with an enclosed particle sorting module, such as those described in U.S. Patent Publication No. 2017/0299493, filed on Mar. 28, 2017, the disclosure of which is incorporated herein by reference. In certain embodiments, particles (e.g., cells) of the sample are sorted using a sort decision module having a plurality of sort decision units, such as those described in U.S. patent application Ser. No. 16/725,756, filed on Dec. 23, 2019, the disclosure of which is incorporated herein by reference.

In some embodiments, the flow cytometer systems are flow cytometric systems, such those described in U.S. Patent No. U.S. Pat. Nos. 10,006,852; 9,952,076; 9,933,341; 9,784,661; 9,726,527; 9,453,789; 9,200,334; 9,097,640; 9,095,494; 9,092,034; 8,975,595; 8,753,573; 8,233,146; 8,140,300; 7,544,326; 7,201,875; 7,129,505; 6,821,740; 6,813,017; 6,809,804; 6,372,506; 5,700,692; 5,643,796; 5,627,040; 5,620,842; 5,602,039; the disclosure of which are herein incorporated by reference in their entirety.

Other methods of analysis may also be used, such as, but not limited to, liquid chromatography-mass spectrometry or gas chromatography-mass spectrometry systems. For example, assaying may include the use of an analytical separation device such as a liquid chromatograph (LC), including a high performance liquid chromatograph (HPLC), a micro- or nano-liquid chromatograph or an ultra-high pressure liquid chromatograph (UHPLC) device, a capillary electrophoresis (CE), or a capillary electrophoresis chromatograph (CEC) apparatus. Mass spectrometer (MS) systems may also be used to assay the reagent compositions, e.g., dye compositions. Examples of mass spectrometers may include, but are not limited, to electrospray ionization (ESI), atmospheric pressure chemical ionization (APCI), electron impact (EI), atmospheric pressure photoionization (APPI), matrix-assisted laser desorption ionization (MALDI) or inductively coupled plasma (ICP) ionization, for example, or any combination thereof. Likewise, any of a variety of different mass analyzers may be employed, including time of flight (TOF), Fourier transform ion cyclotron resonance (FTICR), ion trap, quadrupole or double focusing magnetic electric sector mass analyzers, or any hybrid thereof.

In certain embodiments, the subject systems are included in an apparatus that is fully automated. By “fully automated” is meant that the apparatus receives a subject system and prepares a reconstituted composition, e.g., reconstituted dye composition, with little to no human intervention or manual input into the subject systems. In certain embodiments, the subject systems are configured to prepare and analyze the reconstituted composition, e.g., reconstituted dye composition, without any human intervention.

In certain embodiments, the method also includes storing the reconstituted composition, e.g., reconstituted dye composition, for a period of time. The reconstituted composition, e.g., reconstituted dye composition, may be stored for a period of time before, during and/or after assaying the reconstituted composition, e.g., reconstituted dye composition. In some instances, the reconstituted composition, e.g., reconstituted dye composition, is stored for a period of time such as 24 hours or more, or 48 hours or more, or 72 hours or more, or 4 days or more, or 5 days or more, or 6 days or more, or 1 week or more, or 2 weeks or more, or 3 weeks or more, or 4 weeks or more, or 2 months or more, or 3 months or more, or 4 months or more, or 5 months or more, or 6 months or more, or 9 months or more, or 1 year or more. In certain cases, the reconstituted composition is stored for 24 hours or more. In certain cases, the reconstituted composition is stored for 48 hours or more. In certain cases, the reconstituted composition is stored for 72 hours or more. In certain cases, the reconstituted composition is stored for 1 week or more. In certain cases, the reconstituted composition is stored for 2 weeks or more. In certain cases, the reconstituted composition is stored for 3 weeks or more.

Embodiments of the method may further include shipping the reconstituted composition to a remote location. A “remote location,” is a location other than the location at which the dye composition is reconstituted. For example, a remote location could be another location (e.g., office, lab, etc.) in the same city, another location in a different city, another location in a different state, another location in a different country, etc. As such, when one item is indicated as being “remote” from another, what is meant is that the two items can be in the same room but separated, or at least in different rooms or different buildings, and can be at least one mile, ten miles, or one hundred miles or more apart.

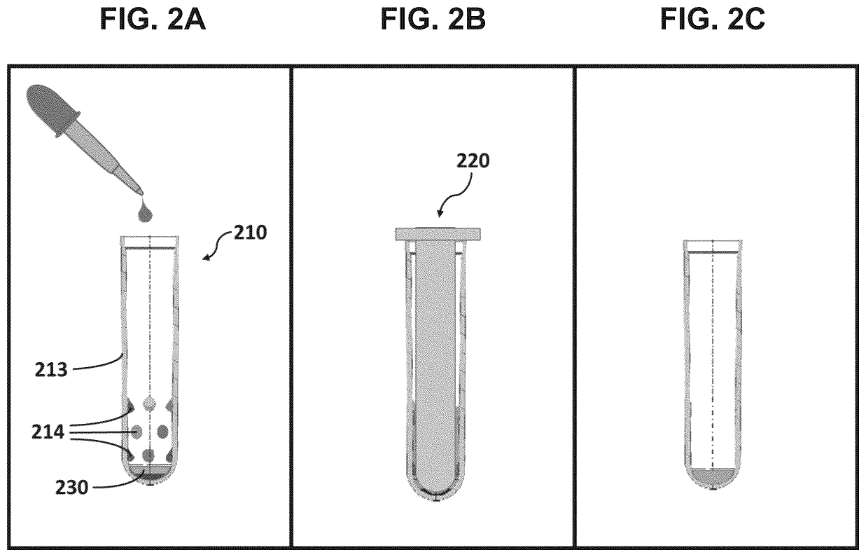

FIGS. 2A-2C provide a depiction of a method of using a system for reconstituting dried reagent compositions in accordance with an embodiment of the invention. In FIG. 2A, a volume of liquid 230 (e.g., a biological liquid sample) is introduced into the liquid container 210. In FIG. 2B, the solid volume displacer 220 is introduced into the liquid container 210 in a manner sufficient to displace the volume of liquid 230 up the inner surface of the wall of the liquid container 213 to reconstitute the dried reagent compositions 214. In FIG. 2C, following reconstitution, the assembly of the liquid container 210, the solid volume displacer 220 and the volume of liquid 230 is disassembled by removing the solid volume displacer 220. The liquid 230 containing the reconstituted reagents can then be collected for use in analytical applications.

### Kits

Aspects of the present disclosure also include kits. The kits may include, e.g., a system for reconstituting dried reagent compositions according to any of the embodiments described herein. Aspects of the system for reconstituting dried reagent compositions may include a liquid container and a solid volume displacer, e.g., as described above. Aspects of the liquid container may include an open end and a bottom separated by a wall therebetween, wherein an inner surface of the wall includes a dried reagent composition. Aspects of the solid volume displacer may include a first end and a second end and a body therebetween, the second end and the body configured to be positioned inside of the liquid container.

In certain embodiments, the kit includes a subject system for reconstituting dried reagent compositions and a packaging configured to hold the system. The packaging may be a sealed packaging, e.g., a water vapor-resistant container, optionally under an air-tight and/or vacuum seal. In some embodiments, the packaging may protect its internal contents (e.g., the subject systems) from light. In these instances, the packaging may protect against any range or spectrum of light wavelengths including, e.g., visible light, UV light, light in and/or near the excitation spectrum of any enclosed dyes, etc. In certain instances, the packaging is a sterile packaging, configured to maintain the device enclosed in the packaging in a sterile environment. By “sterile” is meant that there are substantially no microbes (such as fungi, bacteria, viruses, spore forms, etc.). In some embodiments, the liquid container and the solid volume displacer are included in the same packaging. In other instances, the liquid container and the solid volume displacer are included in separate packaging.

The kits may further include a buffer. For instance, the kit may include a buffer, such as a sample buffer, a wash buffer, an assay buffer, and the like. The kits may further include additional reagents, such as but not limited to, detectable labels (e.g., fluorescent labels, colorimetric labels, chemiluminescent labels, multicolor reagents, avidin-streptavidin associated detection reagents, radiolabels, gold particles, magnetic labels, etc.), and the like. In certain embodiments, the kits may also include a calibration standard. For example, the kits may include a set of labelled beads, such as a set of standard fluorescently labelled beads.

In addition to the above components, the subject kits may further include instructions for practicing the subject methods. These instructions may be present in the subject kits in a variety of forms, one or more of which may be present in the kit. One form in which these instructions may be present is as printed information on a suitable medium or substrate, e.g., a piece or pieces of paper on which the information is printed, in the packaging of the kit, in a package insert, etc. Another means would be a computer readable medium, e.g., CD, DVD, Blu-Ray, computer-readable memory (e.g., flash memory), etc., on which the information has been recorded or stored. Yet another form that may be present is a website address which may be used via the Internet to access the information at a removed site. Any convenient form of instructions may be present in the kits.

### Utility

The subject systems and methods find use in applications where cell analysis from a biological sample may be desired for research, laboratory testing or for use in therapy. In some embodiments, the subject systems and methods facilitate analysis of cells obtained from fluidic or tissue samples such as specimens for diseases, including but not limited to cancer. Systems and methods of the present disclosure also allow for analyzing cells from a biological sample (e.g., organ, tissue, tissue fragment, fluid) with enhanced efficiency and low cost.

The subject systems and methods find use in applications where the analysis of a sample using dried reagent compositions (e.g., dye compositions) is desired. For example, the subject systems and methods find use in applications where the analysis of a sample using dried polymeric dye compositions is desired. Embodiments of the subject systems and methods also find use in applications where analysis of a sample using dried polymeric dye compositions in combination with dried non-polymeric dye compositions is desired. Thus, the subject systems and methods find use in applications where a sample is analyzed for analytes of interest using corresponding dried polymeric dye compositions. In some cases, where non-polymeric dye compositions are also included in the liquid containers of the system, the subject systems and methods find use in applications where a sample is analyzed for analytes of interest using corresponding dried polymeric dye compositions and dried non-polymeric dye compositions.

The subject systems and methods find use in applications where a minimization of the volume of liquid required to reconstitute or rehydrate a dried reagent composition (e.g., polymeric dye composition) is desired. As described herein, embodiments of the subject systems and methods provide a liquid container with an inner wall having a dried reagent composition and a solid volume displacer configured to be positioned inside of the liquid container to occupy a majority of the liquid container volume below the top of the dried reagent composition. As such, the introduction of the solid volume displacer into the liquid container in a manner sufficient to displace the liquid up the inner surface of the wall of the liquid container to reconstitute the dried reagent composition facilitates a minimization of the volume of liquid required to reconstitute or rehydrate the dried reagent composition (e.g., polymeric dye composition). A minimization in the volume of liquid required to reconstitute or rehydrate a dried reagent composition may facilitate a higher reagent concentration after reconstitution or rehydration. A higher reagent concentration after reconstitution or rehydration may facilitate the collection of more precise and/or accurate data with respect to the assays performed using the subject systems and/or a lower cost of performing the assays using the subject systems. For instance, the subject systems and methods may facilitate a reduction in the volume of liquid required to reconstitute or rehydrate a dried reagent composition as compared to systems in which dried reagent compositions are provided but other methods of moving a liquid into the dried reagent composition (e.g., vortexing) are relied upon to reconstitute the dried reagent composition.

The subject systems and methods find use in applications where the analysis of a sample using two or more reagents (e.g., dye compositions) is desired. For example, the subject systems and methods find use in applications where the analysis of a sample using two or more polymeric dye compositions is desired. Embodiments of the subject systems and methods also find use in applications where analysis of a sample using two or more polymeric dye compositions in combination with one or more non-polymeric dye compositions is desired. Thus, the subject systems and methods find use in applications where a sample is analyzed for two or more analytes of interest using two or more corresponding polymeric dye compositions. In some cases, where non-polymeric dye compositions are also included in the liquid containers, the subject systems and methods find use in applications where a sample is analyzed for two or more analytes of interest using two or more corresponding polymeric dye compositions and non-polymeric dye compositions.

The subject systems and methods find use in applications where a minimization in dye-dye interactions is desired. As described herein, embodiments of the subject systems and methods provide two or more dried polymeric dye compositions that are distinctly positioned on an inner surface of the wall of the liquid container. As such, the distinct positioning of the dye compositions relative to each other on the inner surface of the wall of the liquid container facilitates a minimization in dye-dye interactions. A minimization in dye-dye interactions may facilitate the collection of more precise and/or accurate data with respect to the assays performed using the subject systems. For instance, the subject systems and methods may facilitate a reduction in dye-dye interactions as compared to containers in which two or more dye compositions are provided but are not distinctly positioned relative to each other. Further, the distinct positioning of the dye compositions relative to each other on the inner surface of the wall of the liquid container may result in dye compositions being positioned further and further from the bottom of the liquid container as additional dye compositions are added. The positioning of dye compositions further and further from the bottom of the liquid container may result in a larger volume of liquid being required to reconstitute or rehydrate the dye compositions. As such, the distinct positioning of the dye compositions relative to each other on the inner surface of the wall of the liquid container when paired with the introduction of the solid volume displacer into the liquid container in a manner sufficient to displace a volume of liquid up the inner surface of the wall of the liquid container to reconstitute the dye compositions may facilitate the collection of more precise and/or accurate data with respect to the assays performed using two or more dye compositions in the subject systems.

The following examples are offered by way of illustration and not by way of limitation.

### EXAMPLES

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g., amounts, temperature, etc.) but some experimental errors and deviations should be accounted for. Unless indicated otherwise, parts are parts by weight, molecular weight is weight average molecular weight, temperature is in degrees Centigrade, and pressure is at or near atmospheric. In addition, common laboratory protocol abbreviations may be used (e.g., hr=hours, min=minutes, ml=milliliters, ul=microliters, rpm=revolutions per minute, g (in the context of centrifugation)=times the force of gravity, etc.).

The following experiments compare systems of reconstituting dried reagent compositions of the present invention with prior art systems and methods of reconstituting dried reagent compositions.

### Materials and Methods

Dye compositions are dispensed onto the inner surface of the wall of 12×75 mm tubes using, e.g., a liquid handler device in order to create liquid containers in accordance with an embodiment of the invention. The dye compositions are dispensed up to a distance of 20 mm from the bottom of the tube and then allowed to dry.

Three embodiments of solid volume displacers in accordance with embodiments of the invention are machined. Solid volume displacer 1 is machined such that the diameter of the outside surface of the body of the displacer is 1 mm less than the diameter of the inner surface of the wall of the liquid container. The first end of solid volume displacer 1 is configured as a flange that prevents the second end of the displacer from contacting the bottom of the liquid container. Solid volume displacers 2 and 3 are both machined such that the diameter of the outside surface of the body of the displacer is 0.5 mm less than the diameter of the inner surface of the wall of the liquid container. The first end of solid volume displacer 2 is configured as a flange that prevents the second end of the displacer from contacting the bottom of the liquid contain. The first end of solid volume displacer 3 is configured as a flange that allows the second end of the displacer to contact the bottom of the liquid container.

The control method is tested by filling the liquid container with a liquid until it is observed that all dried dye compositions of the liquid container have been reconstituted.

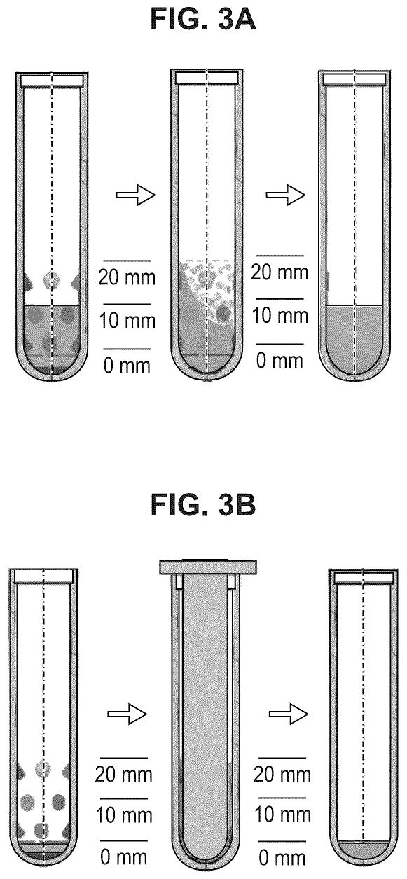

FIG. 3A provides a depiction of the method by which vortexing to reconstitute the dried dye compositions of the liquid container is tested. From left to right, first a volume of liquid is introduced into the liquid container. The liquid container is then vortexed in order to move the introduced volume of liquid up the walls of the liquid container. After vortexing, the liquid container is observed in order to determine whether the introduced volume of liquid was sufficient to reconstitute all dried dye compositions of the liquid container.

FIGS. 2A to 2C provide a depiction of the method (e.g., in accordance with an embodiment of the invention) by which the solid volume displacers are tested. In FIG. 2A, a volume of liquid 230 is introduced into the liquid container 210. In FIG. 2B, the solid volume displacer 220 is introduced into the liquid container 210 in a manner sufficient to displace the volume of liquid 230 up the inner surface of the wall of the liquid container 213. In FIG. 2C, the solid volume displacer 220 is removed from the liquid container 210 and the liquid container is observed in order to determine whether the introduced volume of liquid was sufficient to reconstitute all dried dye compositions of the liquid container.

TABLE 1
Solid volume displacer dimensions and experimental results.

| | | | Liquid displacement | | |
|---|---|---|---|---|---|
| | State of the art | | Solid | Solid | Solid |
| | Con- | Vor- | volume | volume | volume |
| Inputs | trol | texing | displacer 1 | displacer 2 | displacer 3 |
| Diameter (mm) | 9.0 | 9.0 | 8.0 | 8.5 | 8.5 |
| Cylinder fill | 20.0 | 10.0 | 20.0 | 20.0 | 20.5 |
| height (mm) | | | | | |
| | Liquid | Liquid | Displacer | Displacer | Displacer |
| Calculated values | volume | volume | volume | volume | volume |
| Bottom or second | 190.9 | 190.9 | 134.0 | 160.8 | 160.8 |
| end volume (ul) | | | | | |
| Cylinder volume | 1272.3 | 636.2 | 1005.3 | 1134.9 | 1163.3 |
| (ul) | | | | | |
| Required liquid | 1463.2 | 827.0 | 323.8 | 167.5 | 139.1 |
| volume (ul) | | | | | |

The above calculations were performed using the following equations for the volume of a sphere (twice the bottom or second end volume) and the volume of a cylinder, respectively:

Sphere: V=4/3πr³ Cylinder: V=πr²h

### Results

The control method requires 1463.2 ul of liquid to be introduced in order to reconstitute all dried dye compositions. Vortexing to reconstitute the dried dye compositions of the liquid container requires significantly less liquid than the control. In order to reconstitute all dried dye compositions by vortexing, 827 ul of liquid is required to be introduced into the liquid container prior to the liquid container being vortexed.

Solid volume displacer 1 requires 323.8 ul of liquid to reconstitute all dried dye compositions of the liquid container. Accordingly, solid volume displacer 1 requires 77.9% less liquid volume than the control and 60.8% less liquid volume than vortexing to reconstitute all dried dye compositions.

Solid volume displacer 2 requires 167.5 ul of liquid to reconstitute all dried dye compositions of the liquid container. Accordingly, solid volume displacer 2 requires 88.6% less liquid volume than the control and 79.7% less liquid volume than vortexing to reconstitute all dried dye compositions. FIGS. 3A to 3B depict a comparison of vortexing to reconstitute dried dye compositions as compared to using solid volume displacer 2. FIG. 3A from left to right depicts an introduced volume of liquid filling the liquid container to a height of 10 mm up the wall of the liquid container, the liquid container being vortexed, and the resulting volume of liquid containing the relatively diluted reconstituted dye compositions. FIG. 3B from left to right depicts an introduced volume of liquid only partially filling the rounded bottom of the liquid container, solid volume displacer 2 being introduced into the liquid container in a manner sufficient to displace the volume of liquid up the inner surface of the wall of the liquid container, and the resulting volume of liquid containing the reconstituted dye compositions at a relatively high concentration after solid volume displacer 2 has been removed.

Solid volume displacer 3 requires 139.1 ul of liquid to reconstitute all dried dye compositions of the liquid container. Accordingly, solid volume displacer 3 requires 90.5% less liquid volume than the control and 83.2% less liquid volume than vortexing to reconstitute all dried dye compositions.

In at least some of the previously described embodiments, one or more elements used in an embodiment can interchangeably be used in another embodiment unless such a replacement is not technically feasible. It will be appreciated by those skilled in the art that various other omissions, additions and modifications may be made to the methods and structures described above without departing from the scope of the claimed subject matter. All such modifications and changes are intended to fall within the scope of the subject matter, as defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. Moreover, nothing disclosed herein is intended to be dedicated to the public regardless of whether such disclosure is explicitly recited in the claims.

The scope of the present invention, therefore, is not intended to be limited to the exemplary embodiments shown and described herein. Rather, the scope and spirit of present invention is embodied by the appended claims. In the claims, 35 U.S.C. § 112(f) or U.S.C. § 112(6) is expressly defined as being invoked for a limitation in the claim only when the exact phrase “means for” or the exact phrase “step for” is recited at the beginning of such limitation in the claim; if such exact phrase is not used in a limitation in the claim, then 35 U.S.C. § 112 (f) or 35 U.S.C. § 112(6) is not invoked.

1. A system for reconstituting a dried reagent composition, the system comprising:
a liquid container comprising an open end and a bottom separated by a wall therebetween, wherein an inner surface of the wall comprises a dried reagent composition; and
a solid volume displacer configured to be positioned inside of the liquid container to occupy a majority of the liquid container volume below the top of the dried reagent composition.

2-5. (canceled)

6. The system according to claim 1, wherein the dried reagent composition comprises a dye and/or a bead.

7. The system according to claim 6, wherein the dried reagent composition comprises a dye.

8. (canceled)

9. The system according to claim 7, wherein the dye comprises a conjugated polymer.

10. The system according to claim 1, wherein the liquid container comprises a volume of liquid equal to or greater than the volume of the liquid container below the top of the dried reagent composition the solid volume displacer is not configured to occupy.

11-13. (canceled)

14. The system according to claim 1, wherein the inner surface of the wall of the liquid container comprises two or more distinctly positioned dried reagent compositions.

15. The system according to claim 14, wherein the two or more dried reagent compositions are positioned at separate locations on the inner surface of the wall of the liquid container.

16. The system according to claim 1, wherein the inner surface of the wall of the liquid container comprises six or more distinctly positioned dried reagent compositions.

17-19. (canceled)

20. The system according to claim 1, wherein the liquid container comprises a tube or vial.

21. The system according to claim 1, wherein the solid volume displacer is configured as a pestle.

22-23. (canceled)

24. The system according to claim 1, wherein the solid volume displacer comprises a first end and a second end and a body therebetween, the second end and the body configured to be positioned inside of the liquid container.

25. The system according to claim 24, wherein the body of the solid volume displacer is configured as a cylinder.

26. The system according to claim 25, wherein the body of the solid volume displacer comprises an outside surface that is concentric to the inner surface of the wall of the liquid container.

27-29. (canceled)

30. The system according to claim 25, wherein the outside surface of the body of the solid volume displacer and the wall of the liquid container are tapered.

31. The system according to claim 25, wherein the first end of the solid volume displacer is configured to be positioned outside of the liquid container when the body and the second end of the solid volume displacer are positioned inside of the liquid container.

32. The system according to claim 31, wherein the first end of the solid volume displacer comprises a flange.

33. (canceled)

34. (canceled)

35. The system according to claim 25, wherein the solid volume displacer further comprises a ring of filter media positioned around the outside of the body near the first end.

36. (canceled)

37. (canceled)

38. The system according to claim 1, wherein the solid volume displacer is hollow.

39. (canceled)

31. The system according to claim 31, wherein the second end of the solid volume displacer is rounded and concentric to the bottom of the liquid container.

41-50. (canceled)

51. The system according to claim 1, wherein the liquid container comprises a seal.

52-212. (canceled)
